(19) United States
(12) Patent Application Publication
(10) Pub. No.: US 2020/0004238 A1
(43) Pub. Date: Jan. 2, 2020

(54) METHOD AND APPARATUS FOR CONTROLLING F CHANNEL

(71) Applicant: SZ DJI TECHNOLOGY CO., LTD., Shenzhen (CN)

(72) Inventors: Chaobin CHEN, Shenzhen (CN); Qiming LIU, Shenzhen (CN)

(21) Appl. No.: 16/563,817

(22) Filed: Sep. 6, 2019

Related U.S. Application Data
(63) Continuation of application No. PCT/CN2017/076198, filed on Mar. 9, 2017.

(51) Int. Cl. G05D 1/00; B64C 39/02; G08G 5/00; G05B 19/04; G06F 15/78

(52) U.S. Cl. CPC G05D 1/0022; B64C 39/024; B64C 2201/14; G05B 19/04; G06F 15/78; G08G 5/0095

(57) ABSTRACT

The present disclosure provides an F channel control method. The method includes receiving a mapping signal; parsing an F channel identifier and a specified function from the mapping signal; and mapping the F channel corresponding to the F channel identifier to the specified function.

### CROSS-REFERENCE TO RELATED APPLICATION

This application is a continuation application of International Application No. PCT/CN2017/076198, filed on Mar. 9, 2017, the entire content of which is incorporated herein by reference.

### TECHNICAL FIELD

The present disclosure relates to the field of electrical component control, more specifically, to a method and apparatus to control an F channel.

### BACKGROUND

In an Unmanned Aerial Vehicle (UAV), there are pins that may be configured to receive or transmit signals to allow information to be exchanged between the UAV and an external device. In particular, the external device can an electronic governor, a remote control receiver, a steering gear, an external camera, or the like.

Further, some of the pins in the UAV may be used as an input or an output for specified functions, such as fixing the output of the electronic governor, inputting the remote control signal, etc. The functions of the pins used as the input or the output for these specified functions are fixed and cannot be configured by the user. However, there are also some open pins in the UAV and a user may configure the open pins to easily add the external device to the UAV to meet specific operational needs, such as controlling the retraction of the landing gear and the fan speed, etc., and these open pins generally referred to as F channels (multifunction Port).

At present, the user may configure the functionality of the F channel through an assistant application, which may include a candidate list listing the fixed configuration functions. When the user needs to control the current F channels to implement certain functions, the user may configure the current F channels into the specified functions by selecting the configuration functions corresponding to the specified functions in the candidate list. However, if the specific functions do not exist in the candidate list, the user cannot configure the current F channels to the specified functions through the assistant application. The configurable functions in the candidate list may be predetermined before leaving the factory and may be too targeted to certain functions, resulting in the inflexibility of the configurable functions of the F channels. It should be apparent that the way in which the F channels are configured by the assistant application to implement a specified function has inconveniences such as insufficient openness and limited configurable functions. For example, if the user needs to mount some special industrial application devices on the UAV, and the candidate list does not include the functions corresponding to the mounting of these special industrial application devices, it is often necessary to return the UAV to the factory, and the manufacturer may need to modify the relevant firmware of the UAV based on the user's needs, thereby greatly reducing efficiency.

### SUMMARY

The present disclosure provides a method and apparatus to control an F channel.

One aspect of the present disclosure provides an F channel control method. The method includes receiving a mapping signal; parsing an F channel identifier and a specified function from the mapping signal; and mapping the F channel corresponding to the F channel identifier to the specified function.

Another aspect of the present disclosure provides an F channel control apparatus. The apparatus includes a first receiving module that is configured to receive a mapping signal; a parsing module that is configured to parse an F channel identifier and a specified function from the mapping signal; and a mapping module that is configured to map the F channel corresponding to the F channel identifier to the specified function.

The technical solutions provided in the embodiments of the present disclosure provide a configurable mapping signal that may be used to map the F channel to a specified function to fit the user's need, so the user may dynamically configure the function of the F channel based on the actual operational requirement, thereby improving the flexibility and openness of the system. In addition, the F channel control method and apparatus provided in the embodiments of the present disclosure may also improve the ease of use of the UAV or the flight control system and provide a technical basis for the UAV industry.

### BRIEF DESCRIPTION OF THE DRAWINGS

To describe the technical solutions of the embodiments of the present disclosure more clearly, the following briefly introduces the accompanying drawings used in the description of the embodiments of the present disclosure. Apparently, the accompanying drawings described below illustrate only some exemplary embodiments of the present disclosure, and persons skilled in the art may derive other drawings from the drawings without making creative efforts.

FIG. 1 is a flowchart of a method for controlling an F channel from a control device side according to an embodiment of the present disclosure;

FIG. 2 is a flowchart of a method for controlling an F channel from an external device side according to an embodiment of the present disclosure;

FIG. 3 is a flowchart of another method for controlling an F channel from a control device side according to an embodiment of the present disclosure;

FIG. 4 is a flowchart of another method for controlling an F channel from an external device side according to an embodiment of the present disclosure;

FIG. 5 is a partial structural diagram of an UAV according to an embodiment of the present disclosure;

FIG. 6 is a partial structural diagram of an UAV according to another embodiment of the present disclosure;

FIG. 7 is a partial structural diagram of an UAV according to yet another embodiment of the present disclosure;

FIG. 8 is a schematic structural diagram of an F channel control apparatus on a control device side according to an embodiment of the present disclosure;

FIG. 9 is a schematic structural diagram of an F channel control apparatus on an external device side according to an embodiment of the present disclosure;

FIG. 10 is a schematic structural diagram of an F channel control apparatus on a control device side according to another embodiment of the present disclosure,

FIG. 11 is a schematic structural diagram of an F channel control apparatus on an external device side according to another embodiment of the present disclosure;

FIG. 12 is a general frame diagram of an F channel control apparatus according to an embodiment of the present disclosure; and,

FIG. 13 is a schematic structural diagram of an F channel control apparatus according to another embodiment of the present disclosure.

### DETAILED DESCRIPTION OF THE EMBODIMENTS

The technical solutions according to the embodiments of the present disclosure will be clearly and fully described hereinafter in conjunction with the accompanying drawings in the embodiments of the present disclosure. Obviously, the described embodiments are merely parts of embodiments of the present disclosure, but not all the embodiments. Based on the embodiments in the present disclosure, all the other embodiments obtained by a person skilled in the art will fall within the protection scope of the present disclosure.

The F channel control method and apparatus of the present disclosure will be described in detail below with reference to the accompanying drawings. The features of the embodiments described below may be combined with each other when there is no conflict.

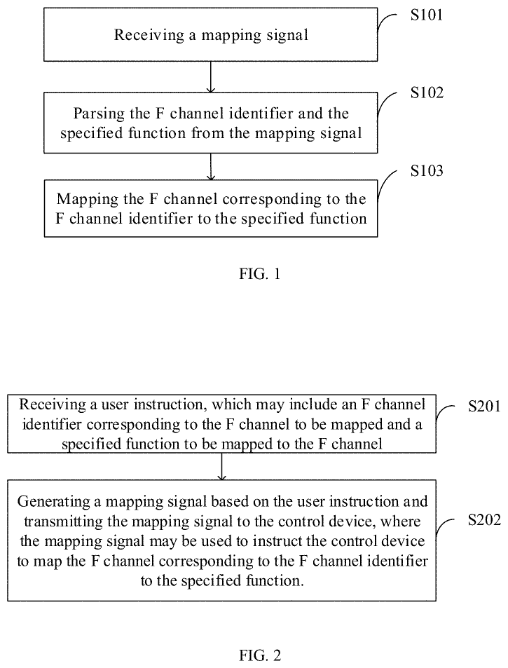

In conjunction with FIG. 1 and FIG. 2, the embodiments of the present disclosure provide an F channel control method, which allows a flexible control of the F channel by the interactions between a control device 100 and an external device 200. In particular, the control device 100 may communicate with the F channel to operate on the F channel.

Referring to FIG. 1, on the side of the control device 100, the method may include the following steps:

Step S101, receiving a mapping signal. The mapping signal may include at least an identifier and a specified function of the F channel to be mapped for determining the F channel to be mapped and the function to be mapped to the F channel.

Step S102, parsing the F channel identifier and the specified function from the mapping signal.

Step S103, mapping the F channel corresponding to the F channel identifier to the specified function.

The control device of the present embodiment may map the F channel to the specified function required by the user based on the received mapping signal. As such, the user may dynamically configure the function of the F channel based on the actual operational requirement to provide a highly flexible and open system.

Referring to FIG. 2, on the side of the external device 200, the method may include:

Step S201, receiving a user instruction, which may include an F channel identifier corresponding to the F channel to be mapped and a specified function to be mapped to the F channel. Step S201 may be performed by a user interacting with the external device 200. When the user needs to implement a certain function through the F channel, the user instruction may be inputted on the external device 200.

Step S202, generating a mapping signal based on the user instruction and transmitting the mapping signal to the control device 100, where the mapping signal may be used to instruct the control device 100 to map the F channel corresponding to the F channel identifier to the specified function. In some embodiments, the external device 200 may transmit the mapping signal to the control device 100 through an Application Programming Interface (API). Further, in some embodiments, a wireless communication connection may be established between the control device 100 and the external device 200 to avoid the entanglement problem caused by a wired connection, thereby providing a more flexible use of the devices. Furthermore, in some embodiments, a wired communication connection may be established between the control device 100 and the external device 200 to ensure the stability and security of the signal transmission.

In particular, Step S201 and Step S202 may both be performed before Step S101.

In the present embodiment, the interaction between the external device 200 and the control device 100 may allow the user to input a user instruction based on the requirement, thereby allowing the dynamic configuration of the functions of the F channel and enabling the user to adjust the functions of the F channel based on the actual needs, so the system may be more flexible, adaptable, and open to meet specific operational needs.

Further, the control device may include at least a Central Processing Unit (CPU). The CPU may be a computer chip or a dedicated chip that may be used for processing and transmitting data. The dedicated chip may be a single chip such as an Advanced RISC Machines (ARM), AVR (an 8-bit RISC chip), etc. In addition, the dedicated chip may be a programmable device such as an Application Specific Integrated Circuit (ASIC) chip, a Field-Programmable Gate Array (FPGA), a Complex Programmable Logic Device (CPLD), etc.

Furthermore, the F channel may be connected to a load 300. For example, when the user needs to operate the load 300 through the F channel, the load 300 may be connected to the F channel.

The load 300 may be a device selected by the user base on a specific job requirement. For example, when the user needs to map the geographical environment of a certain area, the selected load 300 may be a camera; when the user needs to collect environmental data (e.g., temperature, humidity, pressure, etc.) that controls the operation of a system, the selected load 300 may be a sensor or the like. In some embodiments, a load 300 may only need to be connected to a certain F channel and the operation of the load may be performed through the F channel, that is, the load 300 and the F channel may have a one-to-one correspondence, so the related operations on the load 300 may be performed based on the actual business requirement. In some embodiments, a load 300 may need to be connected to two or more F channels. The two or more F channels may cooperate to perform the operation of the load 300.

The external device 200 may be a Software Development Kit (SDK) device or a device equipped with an Application (APP), an assistant software, etc. In particular, the SDK device may include an Onboard SDK (e.g., an SDK device fixed on a device such as an UAV or the like), a Mobile SDK (i.e., a movable SDK device), and the device equipped with the APP or the assistance software may include a mobile phone, a microcomputer, etc. The mapping signal may be generated by the SDK device, the APP, or the assistance software and transmitted to the control device 100.

In some embodiments, the control device 100 may interact with the external device 200 through an API and the user may instruct the operation of the load 300 through the interaction between the control device 100 and the external device 200. In the present embodiment, the data exchange between the control device 100 and the external device 200 may be performed based on a conventional communication protocol.

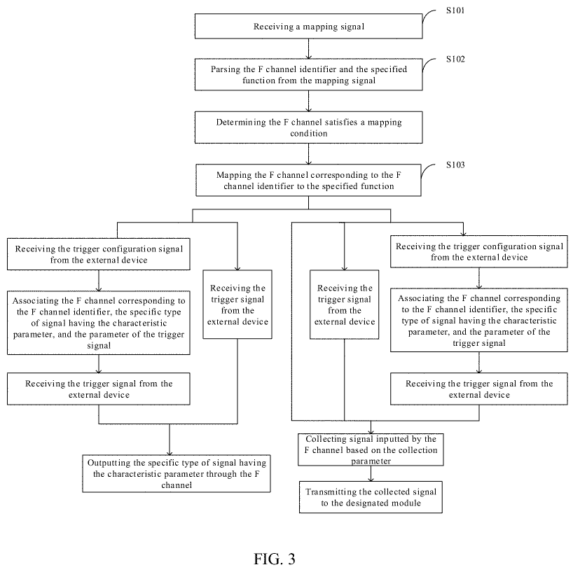

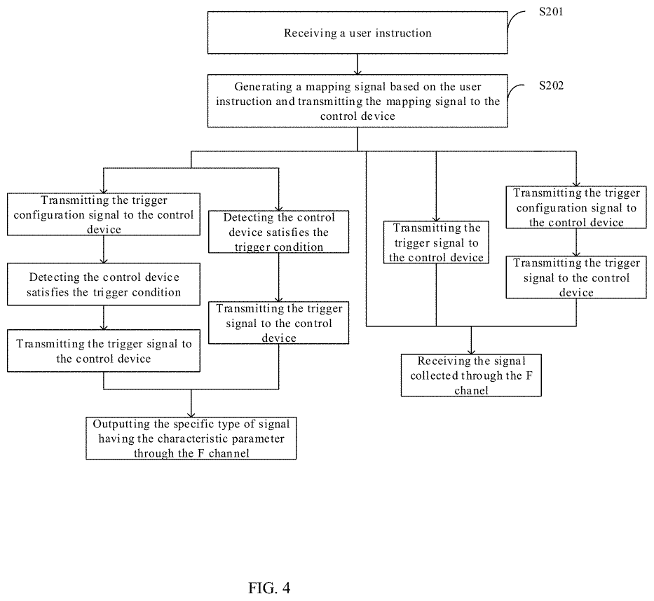

In conjunction with FIG. 3 and FIG. 4, the specified function may include a signal out function and a signal input function. For example, in Table 1, the F channel with identifier 3 (hereinafter referred to as F3) may be mapped to the signal output function, so a signal may be outputted through F3 to eh corresponding load 300 (i.e., the device connected to F3) to instruct the operation of the corresponding mount. Further, the F channel with an identifier 4 (hereinafter referred to as F4) may be mapped to the signal input function, so that the signal of the corresponding the load 300 (i.e., the device connected to F4) may be acquired through F4.

TABLE 1

| F Channel Identifier | Specified Function |
|---|---|
| 3 | Signal Output Function |
| 4 | Signal Input Function |

In one embodiment, the specified function may be a signal output function and the control device 100 may map the F channel corresponding to the F channel identifier into a signal output function, thereby implementing the operational control of the load 300. In particular, the load 300 may be a camera or the like.

Further, the signal output function may include outputting a specific type of signal, such as a Pulse Width Modulation (PWM) signal, a General Purpose Input Output (GPIO) signal, a Digital to Analog (D/A) signal (i.e., an analog signal), etc. That is, the specific type may include signal types such as PWM, GPIO, or D/A. In the present embodiment, after mapping the F channel to the signal output function, the control device 100 may output the specific type of signal to the load 300 through the F channel, thereby implementing and controlling the operation of the load 300.

In actual operation, the signal instructing the operation of the load 300 may need to be dynamically adjusted based on the actual operational requirements, that is, the signal outputted by the F channel may need to be adjusted dynamically, such as dynamically adjusting parameters such as the type, frequency, and pulse width of the signal outputted by the F channel. In the present embodiment, the user instruction may include a characteristic parameter of the specific type of signal, so that the user may dynamically adjust the output signal of the F channel according to the business requirement, thereby enabling the F channel to output the specific type of signal with different characteristic parameters or different types of signals to instruct the load 300 to perform the correspond operations. For example, the F channel may be configured to output a PWM signal with a duty cycle of 10% and a duration of 1 s (second), or a PWM signal with a duty cycle of 20% and a duration of 1 s. Alternatively, the F channel may be configured to output a PWM signal, a GPIO signal or an analog signal.

After the F channel is mapped to the signal output function, the corresponding operation of the load 300 may be performed based on the user's instruction in real time, that is, when the user needs the load 300 to perform the corresponding operation, the F channel may be controlled to output the signal to instruct the load 300 to perform the corresponding operation, and in other cases, the F channel may not need to be controlled.

In some embodiments, the external device 200 may transit a trigger signal to the control device 100 to trigger the control device 100 to output a signal through the F channel to instruct the load 300 to perform the corresponding operation. In particular, the trigger signal may include the F channel identifier and the characteristic parameter of the specific type of signal, and it may be used to instruct the control device 100 to output the specific type of signal having the characteristic parameter through the F channel. In the present embodiment, after receiving the trigger signal, the control device 100 may output the specific type of signal having the characteristic parameter through the F channel, thereby instructing the load 300 to perform the corresponding operation. When the user needs to control the load 300 to perform the corresponding operation, the trigger signal may be transmitted to the control device 100 through the external device 200, and the control device 100 may output the signal for triggering the operation of the load 300 through the F channel to instruct the load 300 to perform the corresponding operation more flexibly and conveniently.

Referring to Table 2, in one embodiment, the load 300 connected to F3 may be a camera, and the trigger signal may be used to instruct F3 to output a PWM signal with a frequency of 50 Hz, a duty ratio of 10%, and a duration of is to drive the camera to acquire images.

TABLE 2

| | | Characteristic Parameter | | |
|---|---|---|---|---|
| F Channel | Specific Type | Reference | Trigger | |
| Identifier | of Signal | Frequency | Duty Cycle | Duration |
| 3 | PWM Signal | 50 Hz | 10% | 1 s |

In other examples, after receiving the trigger signal transmitted by the external device 200, the control device 100 may trigger the F channel to output the specific type of signal having the characteristic parameter based on a configuration information of the trigger signal, thereby instructing the load 300 to perform the corresponding operation. In some embodiments, the external device 200 may transmit a trigger configuration signal to the control device 100, where the trigger configuration signal may include the F channel identifier, characteristic parameter of the specific type of signal, and a parameter of the trigger signal. The parameter of the trigger signal may be used to indicate a trigger signal, which may be used to instruct the control device 100 to output the specific type of signal having the characteristic parameter through the F channel. After receiving the trigger configuration signal, the control device 100 may associate the F channel corresponding to the F channel identifier, the specific type of signal having the characteristic parameter, and the parameter of the trigger signal.

In some embodiments, the control device 100 may store the corresponding F channel identifier, the specific type of signal having the characteristic parameter, and the parameter of the trigger signal (i.e., a trigger ID) as shown in Table 3, thereby realizing the association between the F channel, specific type of signal, and the trigger signal.

TABLE 3

| | | Characteristic Parameter | | | |
|---|---|---|---|---|---|
| F Channel | SpecificType | Reference | Duty | | Trigger |
| Identifier | of Signal | Frequency | Cycle | Duration | ID |
| 3 | PWM Signal | 50 Hz | 10% | 1 s | 1 |
| | | | 15% | 1 s | 2 |
| | | | 20% | 1 s | 3 |

When the user needs to trigger the control device 100 to output the specific type of signal having the characteristic parameter through the F channel to instruct the load 300 to perform the corresponding operation, the trigger signal may be transmitted to the control device 100 through the external device 200. After receiving the trigger signal from the external device 200, the control device 100 may determine the characteristic parameter of the specific type of signal associated with the trigger signal based on the parameter of the trigger signal and output the specific type of signal having the characteristic parameter through the F channel.

Referring to FIG. 3, when the trigger signal received by the control device 100 is 1, after querying Table 3, the trigger signal may be determined to be associated with the PWM signal of F3 with the frequency of 50 Hz, duty cycle of 10%, and duration of 1 s, then the control device may output a PWM signal having a frequency of 50 Hz, a duty ratio of 10%, and a duration of is through F3. In the present embodiment, the user may only need to transmit the trigger ID (i.e., 1) corresponding to the trigger signal through the external device 200, then instruct the control device 100 to output the PWM signal with the frequency of 50 Hz, duty ratio of 10%, and duration of is through the F channel, thereby instructing the load 300 connected to F3 to perform the corresponding operation. It should be apparent that, compared with the previous method of triggering of the F channel to output the signal to instruct the load 300 to perform the corresponding operation (the method corresponding to Table 2), the method of triggering of the F channel to output the signal to instruct the load 300 to perform the corresponding operation (the method corresponding to Table 3) may only require the user to transmit the trigger ID through the external device 200 to the control device 100 when controlling the F channel to output the signal to instruct the load 300 to perform the corresponding operation. Therefore, the F channel identifier, characteristic parameter, etc. may not be require so the operation may be more convenient to the user.

In some embodiments, the trigger configuration signal and the mapping signal may be in the same signal. In one embodiment, the trigger configuration signal and the mapping signal being in the same signal means that the trigger configuration signal and the mapping signal may be two independent signals. However, when the F channel needs to be configured, the external device 200 may place the mapping signal and the trigger configuration signal in the same signal and transmit them to the control device, thereby simplifying the process of configuring the F channel configuration. In another embodiment, the trigger configuration signal and the mapping signal being in the same signal means that the contents of the mapping signal and the trigger configuration signal may be placed in the same signal, and the external device 200 may transmit the signal having the contents of the two signals to the control device 100. Of course, the trigger configuration signal and the mapping signal may also exist independently in two signals, that is, when the F channel needs to be configured, the external device 200 may transmit the mapping signal and the trigger configuration signal to the control device 100, respectively.

Further, the external device 200 may transmit the trigger signal to the control device 100 upon detecting the control device 100 has satisfied a triggering condition to meet the actual needs of the user. In some embodiments, the external device 200 may acquire a location information of the control device 100. For example, the external device 200 may read a GPS information returned by the control device 100 in real time, and the trigger condition may include: determining whether the control device 100 may be located at a specified location based on the location information of the control device 100. That is, when the external device 200 determines that the control device 100 is located at the specified place based on a location signal of the control device 100, the trigger signal may be transmitted to the control device 100 to instruct the control device 100 to output the signal instructing the operation of the load 300.

In particular, the control device 100 may output the specific type of signal having the characteristic parameter through the F channel after determining the trigger signal is from a designated device, thereby ensuring the security of the use of the F channel and preventing the illegal control of the load 300.

In some embodiments, the designated device may be a device that is transmitting the mapping signal, that is, the device that transmits the mapping may be restricted to a unique control source of the F channel, and only when the control device 100 determines that the trigger signal and the mapping signal are from the same device, the specific type of signal having the characteristic parameter may be outputted through the F channel. Otherwise, the control device 100 may not need to indicate further operation of the F channel, thereby preventing illegal operation of the F channel to prevent illegal control of the load 300.

In other embodiments, the designated device may be selected as two or more designated external devices 200. For example, the control device 100 may store the device identifiers of the two or more external devices 200 and mark the two or more external devices 200 as legitimate devices. In the present embodiment, when the control device 100 determines that the device transmitting the trigger signal belongs to the legitimate devices, the specific type of signal having the characteristic parameter may be outputted through the F channel. Otherwise, the control device 100 may not need to indicate further operation of the F channel, thereby preventing illegal operation of the F channel to prevent illegal control of the load 300.

Of course, the designated device may also be unrestricted, so the user may implement the signal output function for the F channel using any device to control the operation of the load 300 connected to the F channel more flexibly and conveniently.

When the designated device is the two or more designated external devices 200 or unrestricted, if the control device 100 receives the trigger signals from the two or more designated external devices 200, the control device 100 may trigger the F channel to output the specific type of signals corresponding to the trigger signal of each external device in sequence based on a sequence of the received trigger signals.

In another embodiment, the specific function may be a signal input function and the control device 100 may map the F channel corresponding to the F channel identifier into the signal input function to collect the signal of the load 300 through the F channel. In particular, the load 300 may be a sensor or the like, such as a temperature sensor, a humidity sensor, a pressure sensor, etc.

Further, the signal input function may include inputting a specific type of signal, for example, a PWM signal, a GPIO, an A/D signal (i.e., a digital signal), etc. In the present embodiment, after mapping the F channel to the signal input function, the control device 100 may collect the signal inputted by the F channel, thereby collecting the signal of the load 300.

In the present embodiment, after Step S103, the control device 100 may further collect the signal inputted by the F channel based on a collection parameter to filter out data not meeting the requirement. In particular, the collection parameter may include parameters such as maximum resolution, sampling rate, signal range, and the like. Further, the configuration of the collection parameters may be determined based on the actual needs. In some embodiments, the F channel may have a predetermined collection parameter of the signal inputted by the F channel, that is, the F channel may uniformly adopt a default parameter. After the F channel is configured as a signal input function, the control device 100 may collect the signal inputted by the F channel based on the default parameter of the F channel, thereby simplifying the configuration process. For example, the control device may map F4 into an A/D signal input function. The default parameter of F4 may be a sampling rate of 50 Hz, a detection range of 0-5V, and a resolution of 256, and the control device 100 may collect the F4 input signal based on the default parameter. However, the above-mentioned data collection using default parameter has the disadvantage that the collection parameter cannot be flexibly configured based on the actual requirements, so the system may be less customizable. To overcome this disadvantage, in some embodiments, the mapping signal may include the collection parameter, that is, the collection parameter may be flexibly configured by the external device 200 based on the business requirements. In the present embodiment, before Step S103, the control device 100 may parse the collection parameter of the signal input to the F channel from the mapping signal, so the configuration of the collection parameter may be more flexible as it may be based on the actual needs of the user, the use and customizability of the system may be enhanced, and data packet loss may be prevented.

In the present embodiment, the rules that the control device 100 uses to collect the signal of the load 300 may be determined based on the business requirement. For example, parameters such as the signal type, signal range, signal frequency, and signal resolution of the F channel collection signal may be determined. In some embodiments, the collecting of the signal inputted by the F channel based on the collection parameter by the control device 100 may be performed after receiving the trigger signal, that is, the control device 100 may collect the signal of the load 300 when the user needs to collect the signal of the load 300, thereby avoiding the waste of resources caused by the control device 100 collecting the signals of the load 300 when the user does not need to collect the signal of the load 300. In particular, the trigger signal may include the F channel identifier and the characteristic parameter of the specific type of signal, and the trigger signal may be used to instruct the control device 100 to collect the signal inputted by the F channel based on the collection parameter. In other embodiments, the collecting of the signal inputted by the F channel based on the collection parameter by the control device 100 may be performed when the mapping of the F channel is completed. That is, after the control device 100 maps the F channel into the signal input function, the signal inputted by the F channel may be immediately collected to obtain the signal of the load 300 to simplify the configuration process and increase the ease of use.

In one embodiment, after the external device 200 transmits the trigger signal to the control device 100, the control device 100 may collect the signal inputted by the F channel to obtain the signal of the load 300 to increase the flexibility of the signal collection process.

In another embodiment, the trigger signal may need to be configured before the external device 200 transmits the trigger signal to the control device 100. In some embodiments, the external device 200 may transmit a trigger configuration signal to the control device 100, where the trigger configuration signal may include the F channel identifier, characteristic parameter of the specific type of signal, and the parameter of the trigger signal. The parameter of the trigger signal (i.e., the trigger ID) may be used to indicate a trigger signal, which may be used to instruct the control device 100 to collect the signal inputted by the F channel based on the collection parameter. After receiving the trigger configuration signal from the external device 200, the control device 100 may associate the F channel corresponding to the F channel identifier, the collection parameter, and the parameter of the trigger signal. Referring to Table 4, the control device 100 may store the corresponding F channel identifier, the collection parameter, and the parameter of the trigger signal, thereby realizing the association between the F channel and the collection parameter.

TABLE 4

| | | Collection Parameter | | | | |
|---|---|---|---|---|---|---|
| F | Specific | Samp- | Detection | Detection | | |
| Channel | Type of | ling | Upper | Lower | Resol- | Trigger |
| Identifier | Signal | Rate | Bound | Bound | ution | ID |
| 4 | A/D | 50 Hz | 0 | 5 V | 256 | 1 |
| | Signal | | 0 | 10 V | 256 | 2 |

After the control device 100 receives the trigger signal from the external device 200, the control device 100 may determine the collection parameter associated with the trigger signal based on the parameter of the trigger signal, and collect the signal inputted by the F channel based on the associated collection parameter. For example, referring to Table 4, when the control device 100 receives the trigger signal transmitted from the external device 200 is 1, the control device 100 may collect the signal of F4 based on the sampling rate of 50 Hz, sampling signal range of 0-5V, and resolution of 256 to obtain the signal of the load 300 connected to F4. In the present embodiment, by pre-configuring the trigger signal, when triggering the control device 100 to collect the signal inputted by the F channel, the user may only need to transmit the trigger ID to the control device 100, which eliminate the need to carry the F channel identifier, etc., so the subsequent operations may be relatively simple.

In order to facilitate the viewing and storage of the collected data, the control device 100 may need to transmit the collected signals to a designated module after collecting the signals inputted by the F channel based on the collected parameters. In some embodiments, the designated module may be a module that is used to transmit the mapping signal, that is, the designated module may be restricted to a unique receiving source of the collected signals to ensure data security. In the present embodiment, the designated module may be the external device 200 that is used to receive signals collected through the F channel. In some embodiments, the reception of the signals collected through the F channel by the external device 200 may be performed after the mapping signal is transmitted. That is, after the external device 200 transmits the mapping signal to the control device 100, the control device 100 may collect the signal of the load 300 through the F channel and return it to the external device 200 to ensure the integrity of the signal collected on the load 300 and prevent data loss. Further, the reception of the signals collected through the F channel by the external device 200 may be performed after the external device 200 transmits the trigger signal. That is, when the user needs to obtain the signal of the load 300, the trigger signal may be transmitted to the control device 100 through the external device 200, so that the signal of the load 300 may be collected by the control device 100 through the F channel and returned to the external device 200, so the collection of data may be performed based on the requirement to increase the flexibility of the data collection.

Referring to FIG. 3, in the present embodiment, before mapping the F channel to the specified function, the control device 100 may also need to determine whether the F channel satisfies a mapping condition. If the F channel satisfies the mapping condition, the control device 100 may performs Step S103, that is, Step S103 may be performed after the control device 100 determines that the F channel satisfies the mapping condition. Otherwise, the control device 100 may not perform the mapping operation on the F channel. By setting the mapping condition, the mapping operation may be performed after the mapping condition is satisfied, thereby improving the security of the F channel.

In one embodiment, the mapping condition may include the F channel not being mapped. In the present embodiment, the control device 100 may include a predetermined mapping table, which may be used to store the channel identifiers of the mapped F channels and the specified functions mapped to the F channels in one-to-one correspondence. Before performing Step S103, the control device 100 may determine whether the identifier of the F channel to be mapped exist in the predetermined mapping table. If the identifier of the F channel to be mapped does not exist in the predetermined mapping table, it may be determined that the F channel has not been mapped. If the identifier of the F channel to be mapped exist in the predetermined mapping table, the control device 100 may need to further determine whether the identifier of the F channel to be mapped is tied to any specified function (i.e., mapped). If the identifier of the F channel to be mapped is tied to a specified function, it may be determined that the F channel has been mapped, and the control device 100 may return the result of the failure to the device that transmitted the mapping signal to inform the device that the mapping operation has failed. Otherwise, it may be determined that the F channel has not been mapped.

In another embodiment, the mapping condition may include the parameters describing the specific function being valid. In particular, the parameters describing the specified function may be included in the mapping signal transmitted by the external device 200. In some embodiments, when the specified function is a signal output function, the parameters describing the specific function may include a signal type that may be outputted by the current F channel to be mapped, the specific parameters corresponding to the signal that may be outputted, etc. Further, when the parameters describing the specified function are valid parameters, it may be determined that the parameters describing the specified function are valid. For example, the control device 100 may set the current F channel to be mapped to output only a PWM signal, when the control device 100 determines that the mapping signal from the external device 200 includes the parameter of other signals instructing the F channel to be mapped to output signals other than the PWM signal (e.g., a sine wave signal), it may be determined that the parameter describing the specified function is invalid. That is, the control device 100 may only output a PWM signal through the F channel and may not output other signals that are not PWM signals through the F channel. In some embodiments, when the specified function is a signal input function, the parameters describing the specified function may include a signal type that may be inputted by the current F channel to be mapped, the collection parameters corresponding to the signal that may be inputted, etc. Further, when the parameters describing the specified function are valid parameters, it may be determined that the parameters describing the specified function are valid. For example, the control device 100 may set the current F channel to be mapped so it may only take input of a GPIO signal, when the control device 100 determines that the mapping signal from the external device 200 includes signals instructing the F channel to be mapped to take input signals other than the GPIO signal, it may be determined that the parameter describing the specified function is invalid. That is, the control device 100 may only collection GPIO signals through the F channel and may not collect non-GPIO signals through the F channel. In the present embodiment, the control device 100 may determine whether the parameters describing the specified function are valid after determining the F channel has not been mapped.

In another embodiment, before Step S101, the control device 100 may receive a login information of a user account transmitted by the external device 200 and obtain the permission of the user account based on the login information. In particular, the mapping signal may include the specified function matches the authority of the user account. In some embodiments, the control device may pre-store each user account, when mapping the F channel to be mapped, the corresponding specified function may be mapped to the F channel to be mapped. More specifically, the control device 100 may map the F channel to be mapped to the specified function only when the specific function to be mapped to the F channel to be mapped is within the authority of the current user account, so the security of the use of the F channel may be improved and the illegal control of the F channel may be prevented. In the present embodiment, the determination of whether the F channel has been mapped by the control device 100 may be performed after determining the specified function matches the authority of the user account, thereby preventing the illegal control of the F channel and improving the security of the use of the F channel.

Further, the external device 200 may need to receive the login information of the user account before receiving the user instruction in order to transmit a login signal of the user account to the control device 100. In some embodiments, the login information may include a user account, a login password, etc., which may be directly inputted by the user directly on the external device 200. For example, in one embodiment, the user account may be Administrator, the login password may be 123456. The control device may preset the configurable F channel identifiers of user account of the Administrator to be 3 and 4, where the specific function that may be mapped to F3 may be the signal output function and the specific function that may be mapped to F4 may be the signal input function. After transmitting the login information of the user account to the control device 100, the external device 200 may only have the authority to configure the F channels with identifiers 3 and 4. In particular, the specific function that may be configured on F3 may only be the signal output function and the specific function that may be configured on F4 may only be the signal input function.

In the present embodiment, after Step S103, the control device 100 may further include: cancelling the mapping of the F channel to the specified function so the F channel may be restored to a configurable state in real time to prevent waste of resources. In some embodiments, the cancellation of the mapping between the F channel and the specified function by the control device may be performed after determining a predetermined number of times the specified function may be executed on the F channel. In particular, the number of times the specified function currently mapped to the F channel may be executed may be determined based on the actual needs. For example, the number of executions may be 5, the load 300 may be a camera, the control device may map the F channel to output a PWM signal with the duration of 1 s and duty cycle of 10% to control the camera to acquire images. When the control device 100 determines that the F channel has outputted the PWM signal 5 times, the mapping of the F channel and the output of the PWM signal may be cancelled immediately to place the F channel in an idle state to prevent the waste of resources when the F channel is not being used. In some embodiments, the control device 100 may cancel the mapping between the F channel and the specified function after the control device 100 determines a new mapping signal and its corresponding new specific function may be different than the specified function currently mapped to the F channel, so the mapping of the F channel may be implemented based on the needs of the user.

In addition, in order to update the mapping information of the F channel in real time, when the control device 100 cancels the mapping of the F channel and the specified function, entries of the F channel identifiers and the specified functions mapped to the F channel may be delete from a predetermined mapping table, or the entry of the specified function mapped to the F channel may be deleted from the table. Further, after perform Step S103, the control device 100 may need to store the identifier of the currently mapped F channel and the specified functions currently mapped to the F channel in the predetermined mapping table.

After performing Step S103, it may be possible that the external device 200 may transmit a new mapping signal to the control device 100 again to control the mapping of the F channel. In the present embodiment, after receiving the new mapping signal from the external device 200, the control device 100 may parse out the new specified function corresponding to the F channel identifier from the new mapping signal, and perform one of the following three operations: (a) the F channel may be mapped again to the new specified function, where operation (a) may be performed when the control device determines the new specified function is the same as the specified function currently mapped to the F channel; (b) the mapping between the F channel and the specified function may be cancelled, the F channel may be mapped to the new specified function, and the mapping of the F channel may be implemented in a non-preemptive manner to allow flexible control of the F channel; and (c) the new specified function may be used to overwrite the specified function, and the mapping of the F channel may be implemented in a preemptive manner to simplify the control of the F channel.

In the present embodiment, the external device 200 may query the specified function mapped to the F channel before receiving the user instruction to determine whether the specified function mapped to the F channel is the function needed by the user. For example, the predetermined mapping table may be retrieved from the control device 100 to obtain the specified function mapped to the F channel.

In some embodiments, the F channel may be a configurable pin disposed on the UAV and the F channel control method may be applied to the UAV so the user may configure the F channel to the necessary specified function based on the actual operational requirements. In this way, the ease of use of the UAV may be improved to provide a technical basis for UAV industry. Of course, the F channel may also be a configurable pin on a robot, a car, etc., to allow the user may implement the specified function based on the actual operational requirements.

The following describes an example where the F channel may be a configurable pin disposed on an UAV.

The UAV may include a body, a flight control system and an F channel may be disposed on the body, and the F channel control method mentioned above may be applied to the flight control system.

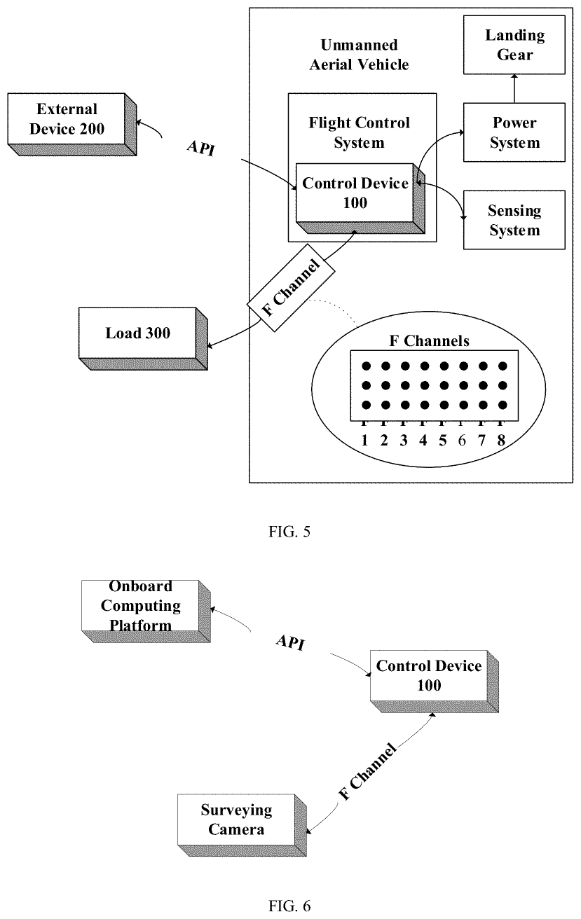

Referring to FIG. 5, the flight control system may include the control device 100, where the F channel may be communicatively connected to the control device 100.

In the present embodiment, the F channel may be one or more configurable pins of the control device 100 that may be open to the user to provide a flexible configuration based on the actual needs of the user to meet specific operational requirements.

The control device 100 in the flight control system may communicate with the external device 200 to facilitate data exchange with the flight control system, such as controlling the flight of the UAV or controlling of the load (when the load is an image acquisition device, the external device 200 may control the image acquisition device). In particular, the external device 200 may be in communication with the UAV and/or the load 300. The communication between the flight control system and the external device 200 may be a wireless communication, and a direct communication may be established between the UAV and the external device 200. The direct communication may be established without any intermediate device or network. Further, an indirect communication may be established between the flight control system and the external device 200. The indirect communication may be established by means of one or more intermediate devices or networks. For example, indirect communication may utilize a telecommunications network. Furthermore, indirect communication may be established by means of one or more routers, communication towers, satellites, or any other intermediary devices or networks. Examples of the communication types may include, but are not limited to, communication via the following manner: Internet, Local Area Network (LAN), Wide Area Network (WAN), Bluetooth, Near-Filed Communication (NFC) technology, mobile data protocol networks such as General Packet Radio Service (GPRS), GSM, Enhance Data GSM Environment (EDGE), 3G, 4G, or Long Term Evolution (LTE), infrared (IR) communication technology, and/or Wi-Fi. Further, the communication types may be wireless, wired, or a combination thereof.

Referring to FIG. 5, the UAV may also include a power system to provide flight power to the UAV, and may include one or more rotating bodies, propellers, blades, engines, motors, wheels, bearings, magnets, nozzles, motors, engines, jet engines, and the like. For example, the rotating body of the power system may be a self-tightening rotating body, a rotating body assembly, or other rotating body power units. The UAV may have one or more power systems and all the power systems may be of the same type. In some embodiments, one or more of the power systems may be of different types. The power system may be mounted to the body by suitable means, such as through a support element (such as a drive shaft). In addition, the power system may be mounted at any suitable location on the body, such as the top, bottom, front, back, side, or any combination thereof.

In some embodiments, the power system may allow the UAV to take off vertically from a surface or land vertically on the surface without the need of any horizontal movement of the UAV (e.g., no taxiing on the runway). In some embodiments, the power system may allow the UAV to hover in a predetermined position and/or direction in the air. Further, one or more power systems may be controlled independent of other power systems. In some embodiments, one or more power systems may be controlled simultaneously. For example, the UAV may have multiple rotating bodies in the horizontal direction to track the lifting and/or pushing of a target. Further, the horizontally rotating bodies may be actuated to allow the UAV to take off vertically, land vertically, and spiral in air. In some embodiments, one or more of the rotating bodies in the horizontal direction may rotate in a clockwise direction, and the other one or more of the rotating bodies in the horizontal direction may rotate in a counterclockwise direction. For example, the number of rotating bodies rotating clockwise may be the same as the number of rotating bodies rotating counterclockwise. The rotation rate of each rotating body in the horizontal direction may vary independently to achieve the lifting and/or pushing operation of each rotating body, so the spatial orientation, velocity, and/or acceleration (e.g., relative to the rotation and translation of up to 3 degrees of freedom) of the UAV may be adjusted.

The UAV may also include a sensing system that may include one or more sensors to sense the spatial orientation, velocity and/or acceleration (e.g., relative to the rotation and translation of up to 3 degrees of freedom), angular acceleration, attitude, position (absolute position or Relative position), etc. of the UAV. The one or more sensors may include any of the sensors described above, including GPS sensors, motion sensors, inertial sensors, proximity sensors, or image sensors. In some embodiments, the sensing system may also be used to collect environmental data on the UAV, such as climatic conditions, potential obstacles about to be approached, location of the geographic features, location of the man-made structures, and the like.

In addition, the UAV may include a landing gear that may be the contact between the UAV and the ground when the UAV is landing. The landing gear may be retracted by the AUV during flight (e.g., when the UAV is cruising) and lowered when landing. Further, the landing gear may be fixedly mounted on the UAV and always in a lowered state.

The load 300 may be disposed on the body of the UAV for securing purposes. In the present embodiment, the load may also be referred to as a mounting device. The load 300 may be a device that implements a specific function, for example, an image capturing function, a detection function, an agricultural operation function, and the like, and is not specifically limited herein. The common load 300 may be a combination of an image acquisition device, an infrared device, a radar device, a spray device, and a carrier such as a suspension or a PTZ platform. In some embodiments, the load 300 mounted on the UAV may be directed located on the UAV. Alternatively, the load 300 mounted on the UAV may further include a carrier connected to the UAV such as a suspension, a PTZ platform, or the like. The carrier may mechanically connect the UAV to the load 300, and the carrier may also include a corresponding power mechanism. The power mechanism may receive control signals and perform the corresponding controls on the load, such as adjusting the angle of the load.

Referring to FIG. 6, which is a partial structural diagram of an UAV according to another embodiment of the present disclosure. The flight control system includes the control device 100, the external device 200, and the load 300. The control device 100 may be connected to the external device 200 through a wired or wireless connection, interact with the external device 200 through an API, and connected to the load 300 through the F channel. In the present embodiment, the external device 200 may be an Onboard computing platform (such as an Onboard SDK device), and the load 300 may be a surveying camera, which may be driven by a PWM signal (in actual applications, different models of cameras may have different requirements for the driving waveforms). Further, the camera's trigger signal may be a PWM signal of 50 Hz with a duty cycle of 10%, and the camera may need a PWM signal of 50 Hz with a duty cycle of 5% to maintain in a standby state. Furthermore, in the present embodiment, the user may be expecting to use the flight control system to drive the camera to acquire images during the flight.

After the flight control system is initialized, the user may need to instruct the control device 100 to complete the configuration of the F channel through the external Onboard computing platform. The Onboard computing platform may transmit the mapping signal to the control device 100 over a wired or wireless connection. Referring to Table 5, the mapping signal may include the F channel to be mapped with identifier 3 and the specified function mapped to the F channel as to output a PWM signal.

After receiving the mapping signal, the control device 100 may first parse out the F channel identifier and the specified function from the mapping signal, and then determine whether F3 has been mapped to other functions. For example, the control device 100 may query the predetermined mapping table that may store the identifier of the mapped F channel and the specified function mapped to the F channel. If it is determined that there is an entry of F3 being mapped in the predetermined mapping table, it may be determined that F3 is occupied, and the control device 100 may return the result of the request failure to the Onboard computing platform, notifying the user that F3 may be unavailable. Further, if it is determined that there is no entry of F3 in the predetermined mapping table or an entry containing F3 in the predetermined mapping table, but the corresponding specified function does not exist in the entry of F3, it may be determined that F3 is in an idle state and the camera may be connected to F3.

After the control device 100 determines that F3 may be in the idle state, in some embodiments, the control device 100 may directly map F3 to a function of outputting a PWM signal. In order to prevent the illegal control of F3, the control device 100 may need to determine whether other parameters in the mapping signal (parameters other than the F channel identifier) are valid before mapping F3. If the control device 100 determines that all other parameters in the mapping signal are valid, the control device 100 may continue to perform the mapping operation on F3, otherwise, the control device 100 may stop the mapping operation on F3. For example, when the control device 100 determines that the signal type is a PWM signal, the PWM reference frequency is within the support range, and the default duty ratio is less than 100%, the parameters may be determined to be valid, and the control device 100 may continue to perform the mapping operation on F3, otherwise, the parameters may be determined to be invalid, and the control device 100 may stop the mapping operation on F3.

In some embodiments, after the control device 100 determines that other parameters in the mapping signal are valid, the information of a successful configuration may be returned to the Onboard computing platform, so the user may receive the progress of configuring F3 in time.

To further prevent the illegal control of the F3, the control device 100 may set the Onboard computing platform that transmitted the mapping signal as the unique control source after determining F3 may be in the idle state. That is, the control device 100 may trigger F3 to output the PWM signal to drive the camera to acquire an image only when receiving the trigger signal transmitted by the Onboard computing platform. If the control device receives a trigger signal transmitted by another device other than the Onboard computing platform, F3 may not be operated to prevent unauthorized user from illegally controlling F3.

In some embodiments, referring to Table 5, the mapping signal transmitted by the Onboard computing platform may also include configuration parameters. The configuration parameters may include a reference frequency of 50 Hz and a default duty cycle of 5%. After the control device 100 successfully configures F3, F3 may transmit a PWM signal with a duty ratio of 5% to the camera at a frequency of 50 Hz, so after F3 is configured, the camera may be placed in a standby state to facilitates subsequent operations of triggering the camera to acquire images.

TABLE 5

Configuration Parameter

| F Channel | Specific Type | Reference | Default |
|---|---|---|---|
| Identifier | of Signal | Frequency | Duty Cycle |
| 3 | PWM Signal | 50 Hz | 5% |

After the above-mentioned configuration process for F3 is completed, the UAV may carry out the mapping operation after the camera is carried to a specific area, and the camera may need to acquire an image every 3 meters. In some embodiments, the control device 100 may transmit a GPS signal to the Onboard computing platform in real time. When the Onboard computing platform determines that the control device 100 may be located at the specific location based on the GPS signal transmitted by the control device 100, a trigger signal may be automatically transmitted to the flight control device 100 every 3 meters.

Referring to FIG. 2 or FIG. 3 for two implementations of the trigger signal. After receiving the trigger signal, the control device 100 may determine whether the trigger signal is valid. For example, the control device may determine whether parameters such as the signal type, trigger duty cycle, etc. are valid. If the trigger signal is valid, the control device 100 may instruct F3 to output a PWM signal with a duty cycle of 10% and a duration of 1 s (that is, the PWM signal is held for 1 s) based on the specific parameter corresponding to the trigger signal to activate the image acquisition function of the camera and complete the corresponding mapping operation.

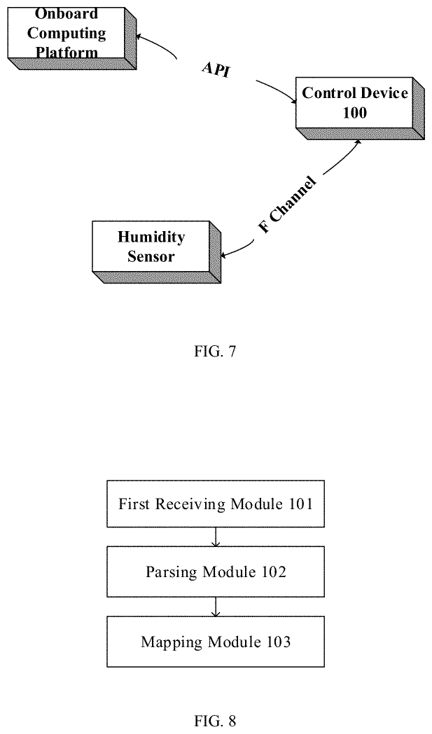

Referring to FIG. 7, which is a partial structural diagram of an UAV according to yet another embodiment of the present disclosure. The flight control system includes the control device 100, the external device 200, and the load 300. The control device 100 may be connected to the external device 200 through a wired or wireless connection, interact with the external device 200 through an API, and connected to the load 300 through the F channel. In the present embodiment, the external device 200 may be an Onboard computing platform (such as an Onboard SDK device), and the load 300 may be a humidity sensor.

After the flight control system is initialized, the user may need to instruct the control device 100 to complete the configuration of the F channel through the external Onboard computing platform. The Onboard computing platform may transmit the mapping signal to the control device 100 via an API. Referring to Table 6, the mapping signal may include the F channel to be mapped with identifier 4 and the specified function mapped to the F channel as an A/D signal input.

After receiving the mapping signal, the control device 100 may first parse out the F channel to be mapped from the mapping signal is F4, map F4 to the A/D signal input, and check the validity of each parameter in the mapping signal one by one.

The control device 100 may determine whether F4 has been mapped to other functions. For example, the control device 100 may query the predetermined mapping table that may store the identifier of the mapped F channel and the specified function mapped to the F channel. If it is determined that there is an entry of F4 being mapped in the predetermined mapping table, it may be determined that F4 is occupied, and the control device 100 may return the result of the request failure to the Onboard computing platform, notifying the user that F4 may be unavailable. Further, if it is determined that there is no entry of F4 in the predetermined mapping table or an entry containing F4 in the predetermined mapping table, but the corresponding specified function does not exist in the entry of F4, it may be determined that F4 is in an idle state and the humidity sensor may be connected to F4.

After the control device 100 determines that F4 may be in the idle state, in some embodiments, the control device 100 may directly map F4 to an A/D signal input function. In order to prevent the illegal control of F4, the control device 100 may need to determine whether other parameters in the mapping signal (parameters other than the F channel identifier) are valid before mapping F4. If the control device 100 determines that all other parameters in the mapping signal are valid, the control device 100 may continue to perform the mapping operation on F4, otherwise, the control device 100 may stop the mapping operation on F4. For example, the control device 100 may determine whether the signal type is an A/D signal, if yes, then the parameter may be determined to be valid, and the control device 100 may continue to perform the mapping operation on F4, otherwise, the parameter may be determined to be invalid, and the control device 100 may stop the mapping operation on F4.

In some embodiments, after the control device 100 determines that other parameters in the mapping signal are valid, the information of a successful configuration may be returned to the Onboard computing platform, so the user may receive the progress of configuring F4 in time.

In the present embodiment, the mapping signal transmitted by the Onboard computing platform may also include configuration parameters. For example, a reference frequency of 50 Hz, sampling range of 0-5V, resolution of 256, etc. After the F channel is configured to input the A/D signal, the control device 100 may start sampling the data of the F4 channel at a sampling frequency of 50 Hz, and return the sampling result to the Onboard computing platform, thereby enabling the user to obtain the humidity data detected by the humidity sensor.

It should be noted that the methods and processes described in the embodiments of the present disclosure may be embodied as code and/or data, which can be stored in a computer-readable storage medium. The storage medium can be any device or medium that can store code and/or data for use by a computer system. The computer readable storage media may include, but is not limited to, volatile memory, non-volatile memory, magnetic and optical storage devices (such as disk drives, magnetic tapes, optical disks, digital versatile disks, or digital video disks, etc.) or media capable of storing code and/or data.

The methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

Corresponding to the embodiments of the F channel control method mentioned above, the embodiment of the present disclosure further provides an F channel control device. For ease of description, the F channel control device is simply referred to as a control device herein.

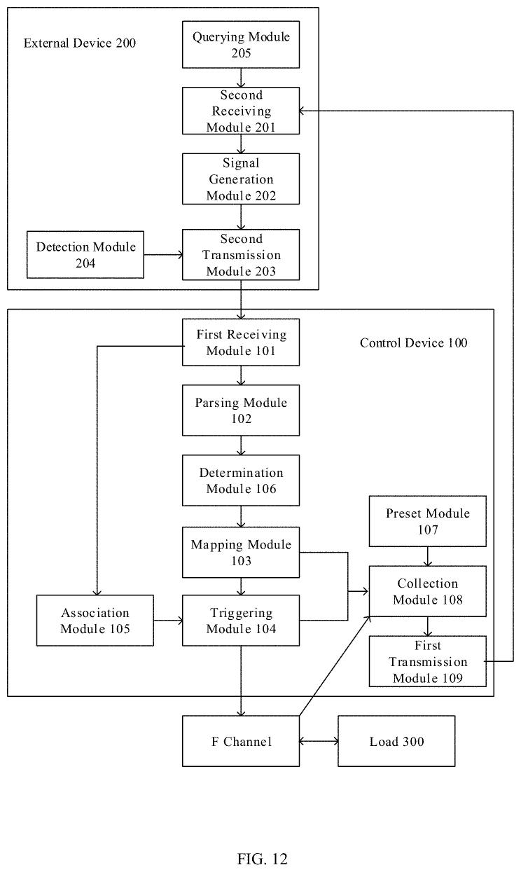

In conjunction with FIG. 8 and FIG. 12, the control device 100 may include a first receiving module 101, a parsing module 102, and a mapping module 103. The first receiving module 101 may be used to receive the mapping signal, the parsing module 102 may be used to parse out the F channel identifier and the specified function from the mapping signal, and the mapping module 103 may be used to map the F channel corresponding to the F channel identifier to the specified function. The control device 100 of the present embodiment may map the F channel to a specified function required by the user based on the received mapping signal, thereby improving the flexibility and openness of the system. In addition, the F channel control device provided in the embodiments of the present disclosure may also improve the ease of use of the flight control system and provide a technical basis for the UAV industry.

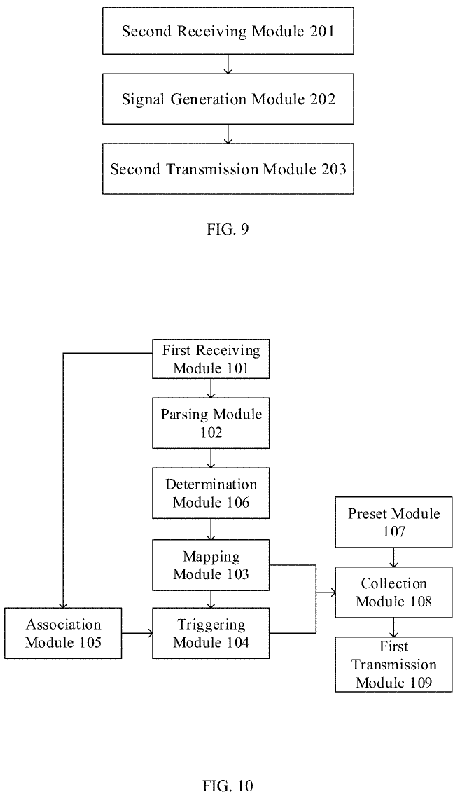

In conjunction with FIG. 9 and FIG. 12, the external device 200 may include a second receiving module 201, a signal generation module 202, and a second transmission module 203. The second receiving module 201 may be used to receive a user instruction, where the user instruction may include the F channel identifier corresponding to the F channel to be mapped and the specified function to be mapped to the F channel. The signal generation module 202 may be used to generate the mapping signal based on the user instruction. The second transmission module 203 may be used to transmit the mapping signal to a first receiving module 101, where the mapping signal may be used to instruct the mapping module 103 to map the F channel corresponding to the F channel identifier to the specified function. In the present embodiment, the interaction between the external device 200 and the control device 100 enables the user to input a user instruction based on the requirement, thereby allowing the dynamic configuration of the functions of the F channel and enabling the user to adjust the functions of the F channel based on the actual needs, so the system may be more flexible, adaptable, and open to meet specific operational needs.

In some embodiments, the second transmission module 203 may transmit the mapping signal to the first receiving module 101 through an API. In particular, the second transmission module 203 and the second receiving module 201 may communicate wirelessly or by wire.

In some embodiments, the external device 200 may be an SDK device or a device equipped with an APP, or an assistant software. The first receiving module 101 may be used to receive the mapping signal transmitted by the SDK device, the APP, or the assistant software.

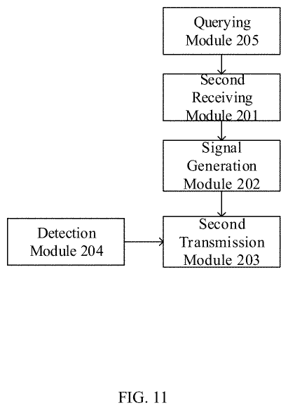

In conjunction with FIG. 10 and FIG. 12, the control device 100 may further include a triggering module 104, an association module 105, a determination module 106, a preset module 107, a collection module 108, and a first transmission module 109.

In conjunction with FIG. 11 and FIG. 12, the external device 200 may further include a detection module 204 and a querying module 205.

In some embodiments, the specified function may include a signal output function and a signal input function.

In conjunction with FIG. 10 and FIG. 12, in one embodiment, the specified function may be a signal output function, and the mapping module 103 may map the F channel corresponding to the F channel identifier into a signal output function to instruct the load 300 to perform a corresponding operation to complete the control of the load 300. In particular, the load 300 may be a camera, etc.

Further, the signal output function may include outputting a specific type of signal, such as a PWM signal, a GPIO signal, a D/A signal, etc. That is, the specific type may include signal types such as PWM, GPIO, or D/A.

In actual operation, the signal instructing the operation of the load 300 may need to be dynamically adjusted based on the actual operational requirements, that is, the signal outputted by the F channel may need to be adjusted dynamically. In the present embodiment, the user instruction may include a characteristic parameter of the specific type of signal, so that the user may dynamically adjust the output signal of the F channel based on the business requirement, thereby enabling the F channel to output the specific type of signal with different characteristic parameters or different types of signals to instruct the load 300 to perform the correspond operations.

After the F channel is mapped to the signal output function, the corresponding operation of the load 300 may be performed based on the user's instruction in real time, that is, when the user needs the load 300 to perform the corresponding operation, the F channel may be controlled to output the signal to instruct the load 300 to perform the corresponding operation, and in other cases, the F channel may not need to be controlled.

In some embodiments, the second transmission module 203 may further be used to transmit a trigger signal to the first receiving module 101. The trigger signal may include the F channel identifier and the characteristic parameter of the specific type of signal, and it may be used to instruct the triggering module 104 output the specific type of signal having the characteristic parameter through the F channel.

After the first receiving module 101 receives the trigger signal from the second transmission module 203, the triggering module 104 may output the specific type of signal having the characteristic parameter through the F channel. The F channel may be trigged to output the signal to instruct the load 300 to perform the corresponding operation based on the actual needs of the user, which is flexible and convenient.

In other examples, after receiving the trigger signal transmitted by the second transmission module 203, the first receiving module may trigger the F channel to output the specific type of signal having the characteristic parameter based on a configuration information of the trigger signal, thereby instructing the load 300 to perform the corresponding operation. In some embodiments, the second transmission module 203 may further transmit a trigger configuration signal to the first receiving module 101, where the trigger configuration signal may include the F channel identifier, characteristic parameter of the specific type of signal, and a parameter of the trigger signal. The parameter of the trigger signal may be used to indicate a trigger signal, which may be used to instruct the triggering module 104 to output the specific type of signal having the characteristic parameter through the F channel.

The first receiving module 101 may receive the trigger configuration signal from the second transmission module 203 and the association module 105 may associate the F channel corresponding to the F channel identifier, the specific type of signal having the characteristic parameter, and the parameter of the trigger signal, thereby enabling the association between the F channel, the specific type of signal, and the trigger signal.

When the user needs the triggering module 104 of the control device 100 to trigger the output of the specific type of signal having the characteristic parameter through the F channel to instruct the load 300 to perform the corresponding operation, the second transmission module 203 may transmit the trigger signal to the first receiving module 101, the first receiving module 101 may receive the trigger signal transmitted by the second transmission module 203, the association module 103 may determine the characteristic parameter of the specific type of signal associated with the trigger signal based on the parameter of the trigger signal, and the triggering module 104 may output the specific type of signal with the characteristic parameter through the F channel to provide a more convenient operation.

In some embodiments, the trigger configuration signal and the mapping signal may be in the same signal. In one embodiment, the trigger configuration signal and the mapping signal being in the same signal means that the trigger configuration signal and the mapping signal may be two independent signals. However, when the F channel needs to be configured, the signal generation module 202 may place the mapping signal and the trigger configuration signal in the same signal and transmit them the first receiving module 101 through the second transmission module 203, thereby simplifying the process of configuring the F channel configuration. In another embodiment, the trigger configuration signal and the mapping signal being in the same signal means that the contents of the mapping signal and the trigger configuration signal may be placed in the same signal, and the signal generation module 202 may transmit the signal having the contents of the two signals to the first receiving device 101. Of course, the trigger configuration signal and the mapping signal may also exist independently in two signals, that is, when the F channel needs to be configured, the second transmission module 203 may transmit the mapping signal and the trigger configuration signal to the first receiving module 101, respectively.

Further, the second transmission module 203 may transmit the trigger signal upon the detection module 204 detecting the control device 100 has satisfied a triggering condition. In some embodiments, the detection module 204 may be used to acquire a location information of the control device 100. For example, the detection module 204 may read a GPS information returned by the control device 100 in real time, and the trigger condition may include: the detection module 204 determining whether the control device 100 may be located at a specified location based on the location information of the control device 100. That is, when the detection module 204 determines that the control device 100 is located at the specified place based on a location signal of the control device 100, the second transmission module 203 may transmit the trigger signal to the first receiving module 101 to instruct the triggering module 104 to output the signal instructing the operation of the load 300.

In particular, the output of the specific type of signal having the characteristic parameter through the F channel by the triggering module 104 may be performed after the determination module 106 determines the trigger may be from a designated device, thereby ensuring the security of the use of the F channel and preventing the illegal control of the load 300.

In some embodiments, the designated device may be a device that is transmitting the mapping signal, that is, the device that transmits the mapping may be restricted to a unique control source of the F channel to improve the security of the F channel control. In other embodiments, the designated device may be two or more designated external devices 200, or the designated device may be unrestricted.

In conjunction with FIG. 11 and FIG. 12, in another embodiment, the specific function may be a signal input function and the mapping module 103 may map the F channel corresponding to the F channel identifier into the signal input function to collect the signal of the load 300 through the F channel. In particular, the load 300 may be a sensor or the like, such as a temperature sensor, a humidity sensor, a pressure sensor, etc.

Further, the signal input function may include inputting a specific type of signal, for example, a PWM signal, a GPIO, an A/D signal, etc.

In the present embodiment,

In the present embodiment, after the mapping module 103 maps the F channel corresponding to the F channel identifier to the specified function, the collection module 108 may collect signal inputted by the F channel based on a collection parameter to filter out data not meeting the requirement. In particular, the collection parameter may include parameters such as maximum resolution, sampling rate, signal range, and the like. Further, the configuration of the collection parameters may be determined based on the actual needs. In some embodiments, the preset module 107 may preset the collection parameter of the signals inputted to the F channel, that is, the F channel may uniformly adopt a default parameter. After the F channel is configured as a signal input function, the collection module 108 may collect the signal inputted by the F channel based on the default parameter of the F channel, thereby simplifying the configuration process. However, the above-mentioned data collection using default parameter has the disadvantage that the collection parameter cannot be flexibly configured based on the actual requirements, so the system may be less customizable. To overcome this disadvantage, in some embodiments, the mapping signal may include the collection parameter, that is, the collection parameter may be flexibly configured by the external device 200 based on the business requirements. In the present embodiment, before the mapping module 103 maps the F channel corresponding to the F channel identifier to the specified function, the parsing module 102 may parse the collection parameter of the signal inputted to the F channel from the mapping signal, so the configuration of the collection parameter may be more flexible as it may be based on the actual needs of the user, the use and customizability of the system may be enhanced, and data packet loss may be prevented.

In the present embodiment, the rules that the collection module 108 uses to collect the signal of the load 300 may be determined based on the business requirement. In some embodiments, the collection module 108 may collect the signal inputted by the F channel based on the collection parameter after the first receiving module 101 received the trigger signal, thereby avoiding the waste of resources caused by the collection module 108 collecting the signals of the load 300 when the user does not need to collect the signal of the load 300. In particular, the trigger signal may include the F channel identifier and the characteristic parameter of the specific type of signal, and the trigger signal may be used to instruct the collection module 108 to collect the signal inputted by the F channel based on the collection parameter. In other embodiments, the collection module 108 may collect the signal inputted by the F channel based on the collection parameter when the mapping module 103 completed the mapping of the F channel. That is, after the mapping module 103 maps the F channel into the signal input function, the signal inputted by the F channel may be immediately collected to obtain the signal of the load 300 to simplify the configuration process and increase the ease of use.

In another embodiment, after the second transmission module 203 transmit the trigger signal to the first receiving module 101, the collection module 108 may collect the signal inputted by the F channel to obtain the signal of the load 300 to increase the flexibility of the signal collection process.

In another embodiment, the trigger signal may need to be configured before the second transmission module transmit the trigger signal to the first receiving module 101. In some embodiments, the second transmission module 203 may transmit a trigger configuration signal to the first receiving module 101, where the trigger configuration signal may include the F channel identifier, characteristic parameter of the specific type of signal, and the parameter of the trigger signal. The parameter of the trigger signal may be used to indicate a trigger signal, which may be used to instruct the collection module 108 to collect the signal inputted by the F channel based on the collection parameter. After the first receiving module 101 receives the trigger configuration signal from the second transmission module 203, the association module 105 may associate the F channel corresponding to the F channel identifier, the collection parameter, and the parameter of the trigger signal, thereby realizing the association between the F channel and the collection parameter.

After the first receiving module 101 receives the trigger signal from the second transmission module 203, the parsing module 102 may determine the collection parameter associated with the trigger signal based on the parameter of the trigger signal, and the collection module 108 may collect the signal inputted by the F channel based on the associated collection parameter. In the present embodiment, by pre-configuring the trigger signal, when triggering the collection module 108 to collect the signal inputted by the F channel, the user may only need to use the second transmission module 203 of the external device 200 to transmit the parameter of the trigger signal to the first receiving module 101 of the control device 100, which eliminate the need to carry the F channel identifier, etc., so the subsequent operations may be relatively simple.

In order to facilitate the viewing and storage of the collected data, the first transmission module 109 may transmit the signals collected by the collection module 108 to a designated module. In some embodiments, the designated module may be a module that is used to transmit the mapping signal, that is, the designated module may be restricted to a unique receiving source of the collected signals to ensure data security. In the present embodiment, the designated module may be the second receiving module 201 of the external device 200, which may be used to receive signals collected through the F channel. In some embodiments, the second receiving module 201 may receive the signals collected through the F channel after the second transmission module 203 transmitted the mapping signal. That is, after the second transmission module 203 transmits the mapping signal to the first receiving module 101, the collection module 108 may collect the signal of the load 300 through the F channel and return it to the second receiving module 201 to ensure the integrity of the signal collected on the load 300 and prevent data loss. Further, the second receiving module 201 may receive the signals collected through the F channel after the second transmission module 203 transmitted the mapping signal. That is, when the user needs to obtain the signal of the load 300, the trigger signal may be transmitted to the first receiving module 101 through the second transmission module 203, so that the signal of the load 300 may be collected by the collection module 108 through the F channel and returned to the second receiving module 201, so the collection of data may be performed based on the requirement to increase the flexibility of the data collection.

Referring to FIG. 10, in the present embodiment, before the mapping module 103 maps the F channel to the specified function, the determination module 106 may determine whether the F channel satisfies a mapping condition. If the determination module 106 determines that the F channel satisfies the mapping condition, the mapping module 103 may map the specified function to the F channel, the mapping module 103 may map the specified function to the F channel corresponding to the F channel identifier after the determining the F channel satisfies the mapping condition. Otherwise, the mapping module 103 may not perform the mapping operation on the F channel. By setting the mapping condition, the mapping operation may be performed after the mapping condition is satisfied, thereby improving the security of the F channel.

In one embodiment, the mapping condition may include the determination module 106 determines the F channel has not been mapped. In the present embodiment, the control device 100 may include a predetermined mapping table, which may be used to store the channel identifiers of the mapped F channels and the specified functions mapped to the F channels in one-to-one correspondence. Before the mapping module 103 maps the specified function to the F channel, the determination module 106 may determine whether the identifier of the F channel to be mapped exist in the predetermined mapping table. If the determination module 106 determines that the identifier of the F channel to be mapped does not exist in the predetermined mapping table, it may be determined that the F channel has not been mapped. If the determination module 106 determines that the identifier of the F channel to be mapped exist in the predetermined mapping table, the determination module 106 may need to further determine whether the identifier of the F channel to be mapped is tied to any specified function (i.e., mapped). If the identifier of the F channel to be mapped is tied to a specific function, it may be determined that the F channel has been mapped, and the first transmission module 109 may return the result of the failure to the device that transmitted the mapping signal to inform the device that the mapping operation has failed. Otherwise, it may be determined that the F channel has not been mapped.

In another embodiment, the mapping condition may include the determination module 106 determines that the parameters describing the specified function is valid. In particular, the parameters describing the specified function may be included in the mapping signal. In some embodiments, when the specified function is a signal output function, the parameters describing the specified function may include a signal type that may be outputted by the current F channel to be mapped, the specific parameters corresponding to the signal that may be outputted, etc. Further, when the determination module 106 determines that the parameters describing the specified function are valid parameters, it may be determined that the parameters describing the specific function are valid. In some embodiments, when the specified function is a signal input function, the parameters describing the specific function may include a signal type that may be inputted by the current F channel to be mapped, the collection parameters corresponding to the signal that may be inputted, etc. Further, when the determination module 106 determines that the parameters describing the specific function are valid parameters, it may be determined that the parameters describing the specific function are valid. In the present embodiment, the determination module 106 may determine whether the parameters describing the specified function are valid after determining the F channel has not been mapped.

In another embodiment, before the second receiving module 201 receives a user instruction, the second receiving module 201 may be used to receive a login information of a user account. The second transmission module 203 may transmit the login information of the user account to the first receiving module 101. Before the first receiving module 101 receives the mapping signal from the second transmission module 203, the first receiving module 101 may be used to receive the login information of the user account transmitted by the second transmission module 203. The parsing module 102 may obtain the permission of the user account based on the login information. In particular, the mapping condition may include the determination module 106 determines that the specified function matches the authority of the user account, so the security of the use of the F channel may be improved and the illegal control of the F channel may be prevented. In the present embodiment, the determination module 106 may determine whether the F channel has been mapped after the determination module determines that the specified function matches the authority of the user account, thereby preventing the illegal control of the F channel and improving the security of the use of the F channel.

In the present embodiment, after the mapping module 103 maps the specified function to the F channel corresponding to the F channel identifier, the method may further include cancelling the mapping of the F channel to the specified function so the F channel may be restored to a configurable state in real time to prevent waste of resources.

In some embodiments, the mapping module 103 may cancel the mapping between the F channel and the specified function after the determination module 106 determines that a predetermined number of times the specified function may be executed on the F channel, so after the user completes the related task by using the F channel, the F channel may be placed in an idle state to present waste of resources. In some embodiments, the mapping module 103 may cancel the mapping between the F channel and the specified function after the determination module 106 determines that a new mapping signal and its corresponding new specific function transmitted by the second transmission module 203 may be different than the specified function currently mapped to the F channel, so the mapping of the F channel may be implemented based on the needs of the user.

After the mapping module 103 maps the F channel corresponding to the F channel identifier to the specified function, the second transmission module 203 may transmit the new mapping signal to the first receiving module 101 again to trigger the mapping module 103 to map the F channel again. In the present embodiment, when the first receiving module 101 receives the new mapping signal from the second transmission module 203, the parsing module 102 may parse out the new specified function corresponding to the F channel identifier from the new mapping signal, and the mapping module 103 may map the new specified function to the F channel again. Alternatively, the mapping module 103 may overwrite the specified function with the new specified function.

In the present embodiment, before the second receiving module 201 receives the user instruction, the querying module 205 may query the specified function mapped to the F channel to determine whether the specified function mapped to the F channel is the function needed by the user.

It should be noted that, corresponding to the F channel control method described above, the F channel of the present embodiment may be one or more configurable pins disposed on a UAV, and the F channel control device of the present embodiment may be applied to a UAV or a flight control system.

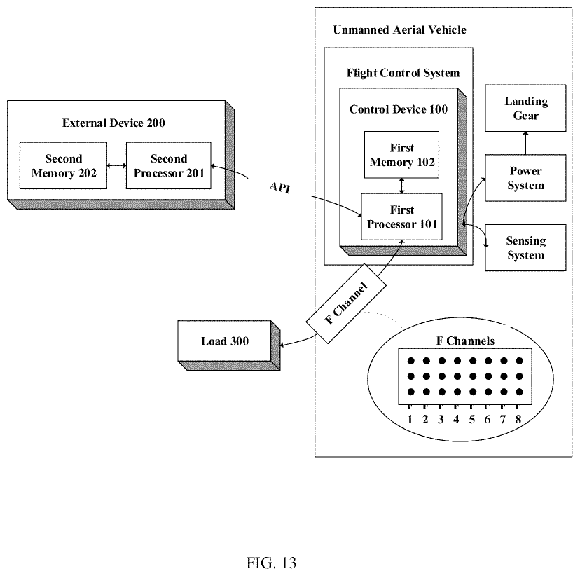

Referring to FIG. 13, corresponding to the embodiments of the F channel control method described above, the embodiments of the present disclosure further provides another F channel control device. The device may include a first processor 101, a second processor 201, a first memory 102, and a second memory 202. In particular, the first memory 102 may be used store computer executable instructions by the first processor 101, and the second memory 202 may be used to store computer executable instructions by the second processor 201.

The F channel control device may provide a flexible control of the F channel by providing the interactions between the first processor 101 and the second processor 201, where the first processor 101 may communicate with the F channel to operate the F channel.

In the present embodiment, the first processor 101 may be used to receive the mapping signal; parse the F channel identifier and the specified function from the mapping signal; and map the F channel corresponding to the F channel identifier to the specified function. In particular, the mapping signal map include at least an identifier of the F channel to be mapped and the specified function to determine the F channel to be mapped and the function to be mapped to the F channel.

The first processor 101 of the present embodiment may map the F channel to the specified function required by the user based on the received mapping signal, so that the user may dynamically configure the function of the F channel based on the actual operational requirement to provide a highly flexible and open system.

Before the first processor 101 performs the process mentioned above, the second processor 201 may be used to receive the user instruction, which may include the F channel identifier corresponding to the F channel to be mapped and the specified function to be mapped to the F channel; and have the user interact with the second processor 201. When the user needs to implement a certain function through the F channel, the user instruction may be inputted on the second processor 201.

Further, the second processor 201 may be used to generate the mapping signal based on the user instruction and transmitting the mapping signal to the first processor 101, where the mapping signal may be used to instruct the first processor 101 to map the F channel corresponding to the F channel identifier to the specified function. In some embodiments, the second processor 201 may transmit the mapping signal to the first processor 101 through an API. Further, in some embodiments, a wireless communication connection may be established between the first processor 101 and the second processor 201 to avoid the entanglement problem caused by a wired connection, thereby providing a more flexible use of the devices. Furthermore, in some embodiments, a wired communication connection may be established between the first processor 101 and the second processor 201 200 to ensure the stability and security of the signal transmission.

In the present embodiment, the interaction between the first processor 101 and the second processor 201 may allow the user to input a user instruction based on the requirement, thereby allowing the dynamic configuration of the functions of the F channel and enabling the user to adjust the functions of the F channel based on the actual needs, so the system may be more flexible, adaptable, and open to meet specific operational needs.

Further, the first processor 101 and the second processor 201 may a computer chip or a dedicated chip that may be used for processing and transmitting data. The dedicated chip may be a single chip such as an AMR, AVR, etc. In addition, the dedicated chip may be a programmable device such as an ASIC chip, a FPGA, a CPLD, etc.

Furthermore, the F channel may be connected to a load 300. For example, when the user needs to operate the load 300 through the F channel, the load 300 may be connected to the F channel.

In some embodiments, the first processor 101 may interact with the second processor 201 through an API and the user may instruct the operation of the load 300 through the interaction between the first processor 101 and the second processor 201. In the present embodiment, the data exchange between the first processor 101 and the second processor 201 may be performed based on a conventional communication protocol.

In some embodiments, the specified function may include a signal out function and a signal input function.

In one embodiment, the specified function may be a signal output function and the first processor 101 may map the F channel corresponding to the F channel identifier into a signal output function, thereby implementing the operational control of the load 300. In particular, the load 300 may be a camera or the like.

Further, the signal output function may include outputting a specific type of signal, such as a PWM signal, a GPIO signal, a D/A signal (i.e., an analog signal), etc. That is, the specific type may include signal types such as PWM, GPIO, or D/A. In the present embodiment, after mapping the F channel to the signal output function, the first processor 101 may output the specific type of signal to the load 300 through the F channel, thereby implementing and controlling the operation of the load 300.

In actual operation, the signal instructing the operation of the load 300 may need to be dynamically adjusted based on the actual operational requirements, that is, the signal outputted by the F channel may need to be adjusted dynamically, such as dynamically adjusting parameters such as the type, frequency, and pulse width of the signal outputted by the F channel. In the present embodiment, the user instruction may include a characteristic parameter of the specific type of signal, so that the user may dynamically adjust the output signal of the F channel according to the business requirement, thereby enabling the F channel to output the specific type of signal with different characteristic parameters or different types of signals to instruct the load 300 to perform the correspond operations.

After the first processor 101 maps the F channel to the signal output function, the corresponding operation of the load 300 may be performed based on the user's instruction in real time, that is, when the user needs the load 300 to perform the corresponding operation, the F channel may be controlled to output the signal to instruct the load 300 to perform the corresponding operation, and in other cases, the F channel may not need to be controlled.

In some embodiments, the second processor 201 may transmit a trigger signal to the first processor 101 to trigger the first processor 101 to output a signal through the F channel to instruct the load 300 to perform the corresponding operation. In particular, the trigger signal may include the F channel identifier and the characteristic parameter of the specific type of signal, and it may be used to instruct the first processor 101 to output the specific type of signal having the characteristic parameter through the F channel. In the present embodiment, after receiving the trigger signal, the first processor 101 may output the specific type of signal having the characteristic parameter through the F channel, thereby instructing the load 300 to perform the corresponding operation. When the user needs to control the load 300 to perform the corresponding operation, the trigger signal may be transmitted to the first processor 101 through the second processor 201, and the first processor 101 may output the signal for triggering the operation of the load 300 through the F channel to instruct the load 300 to perform the corresponding operation more flexibly and conveniently.

In other examples, after receiving the trigger signal transmitted by the second processor 201, the first processor 101 may trigger the F channel to output the specific type of signal having the characteristic parameter based on a configuration information of the trigger signal, thereby instructing the load 300 to perform the corresponding operation. In some embodiments, the second processor 201 may transmit a trigger configuration signal to the first processor 101, where the trigger configuration signal may include the F channel identifier, characteristic parameter of the specific type of signal, and a parameter of the trigger signal. The parameter of the trigger signal may be used to indicate a trigger signal, which may be used to instruct the first processor 101 to output the specific type of signal having the characteristic parameter through the F channel. After receiving the trigger configuration signal, the first processor 101 may associate the F channel corresponding to the F channel identifier, the specific type of signal having the characteristic parameter, and the parameter of the trigger signal.

In some embodiments, the first processor 101 may store the corresponding F channel identifier, the specific type of signal having the characteristic parameter, and the parameter of the trigger signal (i.e., a trigger ID) as shown in Table 3, thereby realizing the association between the F channel, specific type of signal, and the trigger signal.

When the user needs to trigger the first processor 101 to output the specific type of signal having the characteristic parameter through the F channel to instruct the load 300 to perform the corresponding operation, the trigger signal may be transmitted to the first processor 101 through the second processor 201. After receiving the trigger signal from the second processor 201, the first processor 101 may determine the characteristic parameter of the specific type of signal associated with the trigger signal based on the parameter of the trigger signal and output the specific type of signal having the characteristic parameter through the F channel.

In some embodiments, the trigger configuration signal and the mapping signal may be in the same signal. In one embodiment, the trigger configuration signal and the mapping signal being in the same signal means that the trigger configuration signal and the mapping signal may be two independent signals. However, when the F channel needs to be configured, the second processor 201 may place the mapping signal and the trigger configuration signal in the same signal and transmit them to the control device, thereby simplifying the process of configuring the F channel configuration. In another embodiment, the trigger configuration signal and the mapping signal being in the same signal means that the contents of the mapping signal and the trigger configuration signal may be placed in the same signal, and the second processor 201 may transmit the signal having the contents of the two signals to the first processor 101. Of course, the trigger configuration signal and the mapping signal may also exist independently in two signals, that is, when the F channel needs to be configured, the second processor 201 may transmit the mapping signal and the trigger configuration signal to the first processor 101, respectively.

Further, the second processor 201 may transmit the trigger signal to the first processor 101 upon detecting the first processor 101 has satisfied a triggering condition to meet the actual needs of the user. In some embodiments, the second processor 201 may acquire a location information of the first processor 101. For example, the second processor 201 may read a GPS information returned by the first processor 101 in real time, and the trigger condition may include determining whether the first processor 101 may be located at a specified location based on the location information of the first processor 101. That is, when the second processor 201 determines that the first processor 101 is located at the specified place based on a location signal of the first processor 101, the trigger signal may be transmitted to the first processor 101 to instruct the first processor 101 to output the signal instructing the operation of the load 300.

In particular, the first processor may output the specific type of signal having the characteristic parameter through the F channel after determining the trigger is from a designated device, thereby ensuring the security of the use of the F channel and preventing the illegal control of the load 300.

In some embodiments, the designated device may be a device that is transmitting the mapping signal, that is, the device that transmits the mapping may be restricted to a unique control source of the F channel, and only when the first processor 101 determines that the trigger signal and the mapping signal are from the same device, the specific type of signal having the characteristic parameter may be outputted through the F channel. Otherwise, the first processor 101 may not need to indicate further operation of the F channel, thereby preventing illegal operation of the F channel to prevent illegal control of the load 300.

In other embodiments, the designated device may be selected as two or more designated second processors 201. For example, the first processor 101 may store the device identifiers of the two or more second processors 201 and mark the two or more second processors 201 as legitimate devices. In the present embodiment, when the first processor 101 determines that the device transmitting the trigger signal belongs to the legitimate devices, the specific type of signal having the characteristic parameter may be outputted through the F channel. Otherwise, the first processor 101 may not need to indicate further operation of the F channel, thereby preventing illegal operation of the F channel to prevent illegal control of the load 300.

Of course, the designated device may also be unrestricted, so the user may implement the signal output function for the F channel using any device to control the operation of the load 300 connected to the F channel more flexibly and conveniently.

When the designated device is the two or more designated second processors 201 or unrestricted, if the first processor 101 receives the trigger signals from the two or more designated second processors 201, the first processor 101 may trigger the F channel to output the specific type of signals corresponding to the trigger signal of each external device in sequence based on a sequence of the received trigger signals.

In another embodiment, the specific function may be a signal input function and the first processor 101 may map the F channel corresponding to the F channel identifier into the signal input function to collect the signal of the load 300 through the F channel. In particular, the load 300 may be a sensor or the like, such as a temperature sensor, a humidity sensor, a pressure sensor, etc.

Further, the signal input function may include inputting a specific type of signal, for example, a PWM signal, a GPIO, an A/D signal (i.e., a digital signal), etc. In the present embodiment, after mapping the F channel to the signal input function, the first processor 101 may collect the signal inputted by the F channel, thereby collecting the signal of the load 300.

In the present embodiment, after the first processor 101 maps the F channel corresponding to the F channel identifier to the specified function, the first processor 101 may further collect the signal inputted by the F channel based on a collection parameter to filter out data not meeting the requirement. In particular, the collection parameter may include parameters such as maximum resolution, sampling rate, signal range, and the like. Further, the configuration of the collection parameters may be determined based on the actual needs. In some embodiments, the F channel may have a predetermined collection parameter of the signal inputted by the F channel, that is, the F channel may uniformly adopt a default parameter. After the F channel is configured as a signal input function, the first processor 101 may collect the signal inputted by the F channel based on the default parameter of the F channel, thereby simplifying the configuration process. However, the above-mentioned data collection using default parameter has the disadvantage that the collection parameter cannot be flexibly configured based on the actual requirements, so the system may be less customizable. To overcome this disadvantage, in some embodiments, the mapping signal may include the collection parameter, that is, the collection parameter may be flexibly configured by the second processor 201 based on the business requirements.

In the present embodiment, before the first processor 101 maps the F channel corresponding to the F channel identifier to the specified function, the first processor 101 may parse the collection parameter of the signal input to the F channel from the mapping signal, so the configuration of the collection parameter may be more flexible as it may be based on the actual needs of the user, the use and customizability of the system may be enhanced, and data packet loss may be prevented.

In the present embodiment, the rules that the first processor 101 uses to collect the signal of the load 300 may be determined based on the business requirement. For example, parameters such as the signal type, signal range, signal frequency, and signal resolution of the F channel collection signal may be determined. In some embodiments, the collecting of the signal inputted by the F channel based on the collection parameter by the first processor 101 may be performed after receiving the trigger signal, that is, the first processor 101 may collect the signal of the load 300 when the user needs to collect the signal of the load 300, thereby avoiding the waste of resources caused by the first processor 101 collecting the signals of the load 300 when the user does not need to collect the signal of the load 300. In particular, the trigger signal may include the F channel identifier and the characteristic parameter of the specific type of signal, and the trigger signal may be used to instruct the first processor 101 to collect the signal inputted by the F channel based on the collection parameter. In other embodiments, the collecting of the signal inputted by the F channel based on the collection parameter by the first processor 101 may be performed when the mapping of the F channel is completed. That is, after the first processor 101 maps the F channel into the signal input function, the signal inputted by the F channel may be immediately collected to obtain the signal of the load 300 to simplify the configuration process and increase the ease of use.

In one embodiment, after the second processor 201 transmits the trigger signal to the first processor 101, the first processor 101 may collect the signal inputted by the F channel to obtain the signal of the load 300 to increase the flexibility of the signal collection process.

In another embodiment, the trigger signal may need to be configured before the second processor 201 transmits the trigger signal to the first processor 101. In some embodiments, the second processor 201 may transmit a trigger configuration signal to the first processor 101, where the trigger configuration signal may include the F channel identifier, characteristic parameter of the specific type of signal, and the parameter of the trigger signal. The parameter of the trigger signal (i.e., the trigger ID) may be used to indicate a trigger signal, which may be used to instruct the first processor 101 to collect the signal inputted by the F channel based on the collection parameter. After receiving the trigger configuration signal from the second processor 201, the first processor 101 may associate the F channel corresponding to the F channel identifier, the collection parameter, and the parameter of the trigger signal. Referring to Table 4, the first processor 101 may store the corresponding F channel identifier, the collection parameter, and the parameter of the trigger signal, thereby realizing the association between the F channel and the collection parameter.

After the first processor 101 receives the trigger signal from the second processor 201, the first processor 101 may determine the collection parameter associated with the trigger signal based on the parameter of the trigger signal, and collect the signal inputted by the F channel based on the associated collection parameter. For example, referring to Table 4, when the first processor 101 receives the trigger signal transmitted from the second processor 201 is 1, the first processor 101 may collect the signal of F4 based on the sampling rate of 50 Hz, sampling signal range of 0-5V, and resolution of 256 to obtain the signal of the load 300 connected to F4. In the present embodiment, by pre-configuring the trigger signal, when the first processor 101 to collect the signal inputted by the F channel, the user may only need to transmit the trigger ID to the first processor 101, which eliminate the need to carry the F channel identifier, etc., so the subsequent operations may be relatively simple.

In order to facilitate the viewing and storage of the collected data, the first processor 101 may need to transmit the collected signals to a designated module after collecting the signals inputted by the F channel based on the collected parameters. In some embodiments, the designated module may be a module that is used to transmit the mapping signal, that is, the designated module may be restricted to a unique receiving source of the collected signals to ensure data security. In the present embodiment, the designated module may be the second processor 201 that may be used to receive signals collected through the F channel. In some embodiments, the second processor 201 may receive the signals collected through the F channel after the mapping signal is transmitted. That is, after the second processor 201 transmits the mapping signal to the first processor 101, the first processor 101 may collect the signal of the load 300 through the F channel and return it to the second processor 201 to ensure the integrity of the signal collected on the load 300 and prevent data loss. Further, the second processor 201 may receive the signals collected through the F channel after the second processor 201 transmits the trigger signal. That is, when the user needs to obtain the signal of the load 300, the trigger signal may be transmitted to the first processor 101 through the second processor 201, so that the signal of the load 300 may be collected by the first processor 101 through the F channel and returned to the second processor 201, so the collection of data may be performed based on the requirement to increase the flexibility of the data collection.

In the present embodiment, before mapping the F channel to the specified function, the first processor 101 may also need to determine whether the F channel satisfies a mapping condition. If the F channel satisfies the mapping condition, the first processor 101 may map the specified function to the F channel corresponding to the F channel identifier. That is, the first processor 101 may map the specified function to the F channel corresponding to the F channel identifier after the first processor 101 determines that the F channel satisfies the mapping condition. Otherwise, the first processor 101 may not perform the mapping operation on the F channel. By setting the mapping condition, the mapping operation may be performed after the mapping condition is satisfied, thereby improving the security of the F channel.

In one embodiment, the mapping condition may include the F channel not being mapped. In the present embodiment, the first processor 101 may include a predetermined mapping table, which may be used to store the channel identifiers of the mapped F channels and the specified functions mapped to the F channels in one-to-one correspondence. Before the first processor 101 may map the specified function to the F channel corresponding to the F channel identifier, the first processor 101 may determine whether the identifier of the F channel to be mapped exist in the predetermined mapping table. If the identifier of the F channel to be mapped does not exist in the predetermined mapping table, it may be determined that the F channel has not been mapped. If the identifier of the F channel to be mapped exist in the predetermined mapping table, the first processor 101 may need to further determine whether the identifier of the F channel to be mapped is tied to any specified function (i.e., mapped). If the identifier of the F channel to be mapped is tied to a specified function, it may be determined that the F channel has been mapped, and the first processor 101 may return the result of the failure to the device that transmitted the mapping signal to inform the device that the mapping operation has failed. Otherwise, it may be determined that the F channel has not been mapped.

In another embodiment, the mapping condition may include the parameters describing the specific function being valid. In particular, the parameters describing the specified function may be included in the mapping signal transmitted by the second processor 201. In some embodiments, when the specified function is a signal output function, the parameters describing the specific function may include a signal type that may be outputted by the current F channel to be mapped, the specific parameters corresponding to the signal that may be outputted, etc. Further, when the parameters describing the specified function are valid parameters, it may be determined that the parameters describing the specified function are valid. For example, the first processor 101 may set the current F channel to be mapped to output only a PWM signal, when the first processor 101 determines that the mapping signal from the second processor 201 includes the parameter of other signals instructing the F channel to be mapped to output signals other than the PWM signal (e.g., a sine wave signal), it may be determined that the parameter describing the specified function is invalid. That is, the first processor 101 may only output a PWM signal through the F channel and may not output other signals that are not PWM signals through the F channel. In some embodiments, when the specified function is a signal input function, the parameters describing the specified function may include a signal type that may be inputted by the current F channel to be mapped, the collection parameters corresponding to the signal that may be inputted, etc. Further, when the parameters describing the specified function are valid parameters, it may be determined that the parameters describing the specified function are valid. For example, the first processor 101 may set the current F channel to be mapped so it may only take input of a GPIO signal, when the first processor 101 determines that the mapping signal from the second processor 201 includes signals instructing the F channel to be mapped to take input signals other than the GPIO signal, it may be determined that the parameter describing the specified function is invalid. That is, the first processor 101 may only collection GPIO signals through the F channel and may not collect non-GPIO signals through the F channel. In the present embodiment, the first processor 101 may determine whether the parameters describing the specified function are valid after determining the F channel has not been mapped.

In another embodiment, before the first processor 101 receives the mapping signal, the first processor 101 may receive a login information of a user account transmitted by the second processor 201 and obtain the permission of the user account based on the login information. In particular, the mapping signal may include the specified function matches the authority of the user account. In some embodiments, the control device may pre-store each user account, when mapping the F channel to be mapped, the corresponding specified function may be mapped to the F channel to be mapped. More specifically, the first processor 101 may map the F channel to be mapped to the specified function only when the specific function to be mapped to the F channel to be mapped is within the authority of the current user account, so the security of the use of the F channel may be improved and the illegal control of the F channel may be prevented. In the present embodiment, the determination of whether the F channel has been mapped by the first processor 101 may be performed after determining the specified function matches the authority of the user account, thereby preventing the illegal control of the F channel and improving the security of the use of the F channel. Further, the second processor 201 may need to receive the login information of the user account before receiving the user instruction in order to transmit a login signal of the user account to the first processor 101. In some embodiments, the login information may include a user account, a login password, etc., which may be directly inputted by the user directly on the second processor 201. For example, in one embodiment, the user account may be Administrator, the login password may be 123456. The control device may preset the configurable F channel identifiers of user account of the Administrator to be 3 and 4, where the specific function that may be mapped to F3 may be the signal output function and the specific function that may be mapped to F4 may be the signal input function. After transmitting the login information of the user account to the first processor 101, the second processor 201 may only have the authority to configure the F channels with identifiers 3 and 4. In particular, the specific function that may be configured on F3 may only be the signal output function and the specific function that may be configured on F4 may only be the signal input function.

In the present embodiment, after the first processor 101 maps the specified function to the F channel corresponding to the F channel identifier, the first processor 101 may further be used to cancel the mapping of the F channel to the specified function so the F channel may be restored to a configurable state in real time to prevent waste of resources. In some embodiments, the cancellation of the mapping between the F channel and the specified function by the control device may be performed after determining a predetermined number of times the specified function may be executed on the F channel. In particular, the number of times the specified function currently mapped to the F channel may be executed may be determined based on the actual needs. For example, the number of executions may be 5, the load 300 may be a camera, the control device may map the F channel to output a PWM signal with the duration of 1 s and duty cycle of 10% to control the camera to acquire images. When the first processor 101 determines that the F channel has outputted the PWM signal 5 times, the mapping of the F channel and the output of the PWM signal may be cancelled immediately to place the F channel in an idle state to prevent the waste of resources when the F channel is not being used. In some embodiments, the first processor 101 may cancel the mapping between the F channel and the specified function after the first processor 101 determines a new mapping signal and its corresponding new specific function may be different than the specified function currently mapped to the F channel, so the mapping of the F channel may be implemented based on the needs of the user.

In addition, in order to update the mapping information of the F channel in real time, when the first processor 101 cancels the mapping of the F channel and the specified function, entries of the F channel identifiers and the specified functions mapped to the F channel may be delete from a predetermined mapping table, or the entry of the specified function mapped to the F channel may be deleted from the table. Further, after the first processor 101 maps the specified function to the F channel corresponding to the F channel identifier, the first processor 101 may need to store the identifier of the currently mapped F channel and the specified functions currently mapped to the F channel in the predetermined mapping table.

After the first processor 101 maps the specified function to the F channel corresponding to the F channel identifier, it may be possible that the second processor 201 may transmit a new mapping signal to the first processor 101 again to control the mapping of the F channel. In the present embodiment, after receiving the new mapping signal from the second processor 201, the first processor 101 may parse out the new specified function corresponding to the F channel identifier from the new mapping signal, and perform one of the following three operations: (a) the F channel may be mapped again to the new specified function, where operation (a) may be performed when the control device determines the new specified function is the same as the specified function currently mapped to the F channel; (b) the mapping between the F channel and the specified function may be cancelled, the F channel may be mapped to the new specified function, and the mapping of the F channel may be implemented in a non-preemptive manner to allow flexible control of the F channel; and (c) the new specified function may be used to overwrite the specified function, and the mapping of the F channel may be implemented in a preemptive manner to simplify the control of the F channel.

In the present embodiment, the second processor 201 may query the specified function mapped to the F channel before receiving the user instruction to determine whether the specified function mapped to the F channel is the function needed by the user. For example, the predetermined mapping table may be retrieved from the first processor 101 to obtain the specified function mapped to the F channel.

It should also be noted that, corresponding to the F channel control method described above, the F channel of the present embodiment may be one or more configurable pins disposed on an UAV. Further, the F channel control device of present embodiment may be applied to an UAV or a flight control system. Furthermore, the first processor 101 and the first memory 102 may be part of the control device 100, and the second processor 201 and the second memory 202 may be part of the external device 200.

In view of the embodiments of the present disclosure, the F channel control method and apparatus of the present disclosure uses a configurable mapping signal to map the F channel to the specified function to fit the user's need, so the user may dynamically configure the function of the F channel based on the actual operational requirement, thereby improving the flexibility and openness of the system. In addition, the F channel control method and apparatus provided in the embodiments of the present disclosure may also improve the ease of use of the UAV or the flight control system and provide a technical basis for the UAV industry.

Since the device embodiments basically correspond to the method embodiments, reference may be made to the partial description of the method embodiments for the related device embodiments. The described device embodiment is illustrative, where the unit described as a separate part may be or may not be physically separate, components shown as the units may be or may not be a physical unit, i.e., the components may be located at one place, or may distribute on a plurality of network units. A part of or all of the modules may be chosen based on actual needs to achieve the objective of the embodiment. Those skilled in the art may understand and implement the embodiment without creative effort.

It should be noted that, in the disclosure, relational terms such as the first and the second are only used to distinguish an entity or operation from another entity or operation, and it does not necessarily require or imply that there are such actual relationships or sequences among the entities or operations. Furthermore, the term “include”, “comprise” or any other variant thereof intends to cover a non-exclusive inclusion, thus allows a process, a method, an object or an apparatus including a series of elements to include not only the elements, but also other elements not clearly set out, or to include intrinsic elements of the process, method, object or apparatus. In a case that there are no more restrictions, elements defined by the statement “include a . . . ” do not exclude the case that other similar elements exist in the process, method, object or apparatus including the elements.

The embodiments of the present disclosure are described in detail above. The principle and implementation of the present disclosure are described herein through specific examples. The description about the embodiments of the present disclosure is merely provided to help understand the method and core ideas of the present disclosure. In addition, persons of ordinary skill in the art can make variations and modifications to the present disclosure in terms of the specific implementations and application scopes according to the ideas of the present disclosure. Therefore, the content of specification shall not be construed as a limit to the present disclosure.

What is claimed is:

1. An F channel control method, comprising:
receiving a mapping signal;
parsing an F channel identifier and a specified function from the mapping signal; and
mapping the F channel corresponding to the F channel identifier to the specified function.

2. The method of claim 1, wherein the specified function includes a signal output function outputting a specific type of signal.

3. The method of claim 2, further comprising:
receiving a trigger signal, the trigger signal including the F channel identifier and a characteristic parameter of the specific type of signal; and
outputting the specific type of signal having the characteristic parameter through the F channel.

4. The method of claim 2, further comprising:
receiving a trigger configuration signal, the trigger configuration signal including the F channel identifier, the characteristic parameter of the specific type of signal, and a parameter of the trigger signal, the parameter of the trigger signal describing the trigger signal, and the trigger signal triggering the F channel to output the specified type of signal having the characteristic parameter; and
associating the F channel corresponding to the F channel identifier, the specific type of signal having the characteristic parameter, and the parameter of the trigger signal.

5. The method of claim 2, further comprising:
receiving a trigger signal;
determining the specific type of signal having the characteristic parameter associated with a parameter of the trigger signal; and
outputting the specific type of signal through the F channel.

6. The method of claim 3, further comprising:
determining that the trigger signal is from a designated device.

7. The method of claim 1, wherein the specified function includes a signal input function and the F channel is configured with a collection parameter of the signal inputted to the F channel, and the method further includes:
parsing the collection parameter of the signal inputted to the F channel from the mapping signal.

8. The method of claim 7, further comprising:
collecting an input signal of the F channel according to the collection parameter after receiving a trigger signal or after mapping the F channel.

9. The method of claim 8, further comprising:
receiving a trigger configuration signal, the trigger configuration signal including the F channel identifier, the collection parameter, and a parameter of the trigger signal, the parameter of the trigger signal describing a trigger signal, the trigger signal triggering the collection of the signal inputted by the F channel based on the collection parameter; and
associating the F channel corresponding to the F channel identifier, the collection parameter, and the parameter of the trigger signal.

10. The method of claim 9, further comprising:
receiving user account login information;
determining user account authority based on the user account login information; and
mapping the F channel according to a correspondence of the specific function and the user account authority.

11. The method of claim 1, further comprising:
parsing a new specified function corresponding to the F channel identifier from a new mapping signal and executing one of the following operations in response to receiving the new mapping signal:
mapping the F channel to the new specified function; or,
cancelling the mapping of the F channel to the specified function and mapping the F channel to the new specified function, or
overwriting the specified function with the new specified function.

12. An F channel control apparatus, comprising
a first receiving module that is configured to receive a mapping signal;
a parsing module that is configured to parse an F channel identifier and a specified function from the mapping signal; and
a mapping module that is configured to map the F channel corresponding to the F channel identifier to the specified function.

13. The apparatus of claim 12, wherein the specified function includes a signal output function and the signal output function includes outputting a specific type of signal.

14. The apparatus of claim 13, wherein the first receiving module is further configured to receive a trigger signal, the trigger signal including the F channel identifier and a characteristic parameter of the specific type of signal; and
the apparatus further includes a triggering module, the triggering module being configured to output the specific type of signal having the characteristic parameter through the F channel.

15. The apparatus of claim 12, wherein the first receiving module is further configured to receive a trigger configuration signal, the trigger configuration signal including the F channel identifier, the characteristic parameter of the specific type of signal, and a parameter of the trigger signal, the parameter of the trigger signal describing the trigger signal, and the trigger signal triggering the F channel to output the specified type of signal having the characteristic parameter; and
the apparatus further includes an association module, the association module being configured to associate the F channel corresponding to the F channel identifier, the specific type of signal having the characteristic parameter, and the parameter of the trigger signal.

16. The apparatus of claim 14, wherein the triggering module is configured to output the specific type of signal having the characteristic parameter through the F channel after determining the trigger signal is from a designated device.

17. The apparatus of claim 12, wherein the specified function includes a signal input function, and the apparatus further includes:
a preset module that is configured to preset a collection parameter of the signal inputted to the F channel, or
before the mapping module maps the F channel corresponding to the F channel identifier to the specified function, the parsing module is further configured to parse the collection parameter of the signal inputted to the F channel from the mapping signal.

18. The apparatus of claim 17, wherein the first receiving module is further configured to receive a trigger configuration signal, the trigger configuration signal including the F channel identifier, a collection parameter, and a parameter of the trigger signal, the parameter of the trigger signal describing a trigger signal, the trigger signal triggering the collection of the signal inputted by the F channel based on the collection parameter; and
the association module is further configured to associate the F channel corresponding to the F channel identifier, the collection parameter, and the parameter of the trigger signal.

19. The apparatus of claim 12, wherein the parsing module is further configured to parse a new specified function corresponding to the F channel identifier from a new mapping signal and execute one of the following operations in response to the first receiving module receiving the new mapping signal:
mapping the F channel to the new specified function; or,
cancelling the mapping of the F channel to the specified function and mapping the F channel to the new specified function, or
overwriting the specified function with the new specified function.

20. The apparatus of claim 12, wherein the apparatus is a flight controller or an Unmanned Aerial Vehicle (UAV).
